(19) United States
(12) Patent Application Publication
(10) Pub. No.: US 2026/0025677 A1
(43) Pub. Date: Jan. 22, 2026

(54) METHOD FOR WIRELESS COMMUNICATION AND COMMUNICATION DEVICE

(71) Applicant: GUANGDONG OPPO MOBILE TELECOMMUNICATIONS CORP., LTD., Dongguan (CN)

(72) Inventor: Wendong LIU, Dongguan (CN)

(21) Appl. No.: 19/345,328

(22) Filed: Sep. 30, 2025

Related U.S. Application Data
(63) Continuation of application No. PCT/CN2023/087044, filed on Apr. 7, 2023.

(51) Int. Cl. H04W 24/02; H04W 64/00

(52) U.S. Cl. CPC H04W 24/02; H04W 64/00

(57) ABSTRACT

A method for wireless communication and a communication device are provided. The method for wireless communication includes the following. The communication device monitors the prediction performance of the first positioning model according to the at least one network model, where input information of the at least one network model is the output information of the first positioning model, or the input information of the at least one network model is determined based on the output information of the first positioning model, or the input information of the at least one network model is associated with the output information of the first positioning model. Output information of the at least one network model is an estimation of input information of the first positioning model.

### CROSS-REFERENCE TO RELATED APPLICATION(S)

This application is a continuation of International Application No. PCT/CN2023/087044, filed Apr. 7, 2023, the entire disclosure of which is incorporated herein by reference.

### TECHNICAL FIELD

This disclosure relates to the field of communication, in particular to a method for wireless communication and a communication device.

### BACKGROUND

In a new radio (NR) system, artificial intelligence (AI)/machine learning (ML) may be introduced to enhance system performance. For example, AI/ML is introduced for positioning of a terminal device, that is, the accuracy of the positioning of the terminal device is improved by predicting location information of the terminal device with a trained AI/ML model. However, when a wireless propagation environment changes, it may be difficult to ensure the effectiveness of the AI/ML model. How to monitor the effectiveness of the AI/ML model is a problem to be solved.

### SUMMARY

A method for wireless communication and a communication device are provided in the present disclosure.

In a first aspect, a method for wireless communication is provided. The method includes the following. A communication device monitors prediction performance of a first positioning model according to at least one network model, where input information of the at least one network model is output information of the first positioning model, or the input information of the at least one network model is determined based on the output information of the first positioning model, or the input information of the at least one network model is associated with the output information of the first positioning model. Output information of the at least one network model is an estimation of input information of the first positioning model.

In a second aspect, a communication device is provided. The communication device includes a processor and a memory storing a computer program which, when executed by the processor, causes the communication device to monitor prediction performance of a first positioning model according to at least one network model, where input information of the at least one network model is output information of the first positioning model, or the input information of the at least one network model is determined based on the output information of the first positioning model, or the input information of the at least one network model is associated with the output information of the first positioning model. Output information of the at least one network model is an estimation of input information of the first positioning model.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiment described herein.

### BRIEF DESCRIPTION OF THE DRAWINGS

The disclosure is best understood from the following detailed description when read in conjunction with the accompanying drawings.

FIG. 1 is a schematic architectural diagram of a communication system to which embodiments of the present disclosure are applicable.

FIG. 2 is a schematic diagram illustrating a neuron provided in the present disclosure.

FIG. 3 is a schematic diagram illustrating a neural network provided in the present disclosure.

FIG. 4 is a schematic diagram of a convolutional neural network provided in the present disclosure.

FIG. 5 is a schematic structural diagram illustrating a long short-term memory (LSTM) unit provided in the present disclosure.

FIG. 6 is a schematic diagram illustrating a downlink (DL)-based positioning method provided in the present disclosure.

FIG. 7 is a schematic diagram illustrating an uplink (UL)-based positioning method provided in the present disclosure.

FIG. 8 is a schematic diagram illustrating a combination of an artificial intelligence (AI)/machine learning (ML) model and a positioning method provided in the present disclosure.

FIG. 9 is a schematic flowchart of a method for wireless communication provided in embodiments of the present disclosure.

FIG. 10 is a schematic diagram illustrating monitoring of prediction performance of a first positioning model based on a first network model provided in embodiments of the present disclosure.

FIG. 11 is a schematic flowchart illustrating periodic monitoring feedback by a location management function (LMF) entity provided in embodiments of the present disclosure.

FIG. 12 is a schematic flowchart illustrating aperiodic monitoring feedback by an LMF entity provided in embodiments of the present disclosure.

FIG. 13 is another schematic flowchart illustrating aperiodic monitoring feedback by an LMF entity provided in embodiments of the present disclosure.

FIG. 14 is a schematic flowchart illustrating periodic monitoring feedback by a user equipment (UE) provided in embodiments of the present disclosure.

FIG. 15 is a schematic flowchart illustrating aperiodic monitoring feedback by a UE provided in embodiments of the present disclosure.

FIG. 16 is a schematic diagram illustrating monitoring of prediction performance of a first positioning model based on a second network model and a third network model provided in embodiments of the present disclosure.

FIG. 17 is another schematic diagram illustrating monitoring of prediction performance of a first positioning model based on a second network model and a third network model provided in embodiments of the present disclosure.

FIG. 18 is a schematic flowchart illustrating cross check and periodic monitoring feedback performed by an LMF entity provided in embodiments of the present disclosure.

FIG. 19 is another schematic flowchart illustrating periodic monitoring feedback by an LMF entity provided in embodiments of the present disclosure.

FIG. 20 is a schematic block diagram of a communication device provided in embodiments of the present disclosure.

FIG. 21 is a schematic block diagram of another communication device provided in embodiments of the present disclosure.

FIG. 22 is a schematic block diagram of an apparatus provided in embodiments of the present disclosure.

FIG. 23 is a schematic block diagram of a communication system provided in embodiments of the present disclosure.

### DETAILED DESCRIPTION

The following will describe technical solutions of embodiments of the present disclosure with reference to the accompanying drawings in embodiments of the present disclosure. Apparently, embodiments described herein are some embodiments, rather than all embodiments, of the present disclosure. Based on embodiments of the present disclosure, all other embodiments obtained by those of ordinary skill in the art without creative effort shall fall within the protection scope of the present disclosure.

The technical solutions of embodiments of the present disclosure may be applied to various communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), an internet of things (IoT), a wireless fidelity (Wi-Fi), a 5th generation (5G) system, a 6th generation (6G) system, or other communication systems.

Generally speaking, a conventional communication system supports a limited quantity of connections and therefore is easy to implement. However, with development of communication technology, a mobile communication system will not only support conventional communication but also support, for example, device to device (D2D) communication, machine to machine (M2M) communication, machine type communication (MTC), vehicle to vehicle (V2V) communication, sidelink (SL) communication, vehicle to everything (V2X) communication, or the like. Embodiments of the present disclosure can also be applied to these communication systems.

In some embodiments, a communication system in embodiments of the present disclosure may be applied to a carrier aggregation (CA) scenario, a dual connectivity (DC) scenario, a standalone (SA) network deployment scenario, or a non-standalone (NSA) network deployment scenario.

In some embodiments, the communication system in embodiments of the present disclosure may be applied to an unlicensed spectrum, and the unlicensed spectrum may be regarded as a shared spectrum. Alternatively, the communication system in embodiments of the present disclosure may be applied to a licensed spectrum, and the licensed spectrum may be regarded as a non-shared spectrum.

In some embodiments, the communication system in embodiments of the present disclosure may be applied to a frequency range 1 (FR1) frequency band (corresponding to a frequency range of 410 megahertz (MHz) to 7.125 gigahertz (GHz)), or may be applied to an FR2 frequency band (corresponding to a frequency range of 24.25 GHz to 52.6 GHZ), or may be applied to a new frequency band, for example, a high frequency band corresponding to a frequency range of 52.6 GHz to 71 GHz or a frequency range of 71 GHz to 114.25 GHz.

Various embodiments of the present disclosure are described in connection with a network device and a terminal device. The terminal device may also be referred to as a user equipment (UE), an access terminal, a subscriber unit, a subscriber station, a mobile station, a remote station, a remote terminal, a mobile device, a user terminal, a terminal, a wireless communication device, a user agent, or a user device, and the like.

The terminal device may be a station (STA) in a WLAN, a cellular radio telephone, a cordless telephone, a session initiation protocol (SIP) telephone, a wireless local loop (WLL) station, a personal digital assistant (PDA), a handheld device with wireless communication functions, a computing device or other processing device connected to a wireless modem, an in-vehicle device, a wearable device, and a terminal device in a next-generation communication system, for example, a terminal device in an NR network, or a terminal device in a future evolved public land mobile network (PLMN), and the like.

In embodiments of the present disclosure, the terminal device can be deployed on land, which includes indoor or outdoor, handheld, wearable, or in-vehicle. The terminal device can also be deployed on water (such as ships, and the like). The terminal device can also be deployed in the air (such as airplanes, balloons, satellites, and the like).

In embodiments of the present disclosure, the terminal device may be a mobile phone, a pad, a computer with wireless transceiver functions, a virtual reality (VR) terminal device, an augmented reality (AR) terminal device, a wireless terminal device in industrial control, a wireless terminal device in self driving, a wireless terminal device in remote medicine, a wireless terminal device in smart grid, a wireless terminal device in transportation safety, a wireless terminal device in smart city, a wireless terminal device in smart home, an in-vehicle communication device, a wireless communication chip/application specific integrated circuit (ASIC)/system on chip (SoC), etc.

By way of explanation rather than limitation, in embodiments of the present disclosure, the terminal device may also be a wearable device. The wearable device may also be referred to as a wearable smart device, which is a generic term of wearable devices obtained through intelligentization design and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or part of functions of a smart phone, and for example, various types of smart bands and smart jewelries for physical monitoring, of which each is dedicated to application functions of a certain type and required to be used together with other devices such as a smart phone.

In embodiments of the present disclosure, the network device may be a device configured to communicate with a mobile device, and the network device may be an access point (AP) in a WLAN, a base transceiver station (BTS) in GSM or CDMA, or may be a node B (NB) in WCDMA, or may be an evolutional node B (eNB or eNodeB) in LTE, or a relay station or an AP, or an in-vehicle device, a wearable device, a network device or base station (gNB) or a transmission reception point (TRP) in an NR network, a network device in a future evolved PLMN, or a network device in an NTN, etc.

By way of explanation rather than limitation, in embodiments of the present disclosure, the network device may be mobile. For example, the network device may be a mobile device. In some embodiments, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. In some embodiments, the network device may also be a base station deployed on land or water.

In embodiments of the present disclosure, the network device serves a cell, and the terminal device communicates with the network device on a transmission resource (for example, a frequency-domain resource or a spectrum resource) for the cell. The cell may be a cell corresponding to the network device (for example, a base station). The cell may belong to a macro base station, or may belong to a base station corresponding to a small cell. The small cell may include: a metro cell, a micro cell, a pico cell, a femto cell, and the like. These small cells are characterized by small coverage and low transmission power and are adapted to provide data transmission service with high-rate.

Exemplarily, FIG. 1 illustrates a communication system 100 where embodiments of the present disclosure are applied. The communication system 100 may include a network device 110. The network device 110 may be a device for communicating with a terminal device 120 (also referred to as “communication terminal” or “terminal”). The network device 110 can provide a communication coverage for a particular geographical area and communicate with terminal devices in the coverage area.

FIG. 1 exemplarily illustrates one network device and two terminal devices. In some embodiments, the communication system 100 may include multiple network devices, and there can be other quantities of terminal devices in a coverage area of each of the network devices. Embodiments of the present disclosure are not limited in this regard.

In some embodiments, the communication system 100 may further include other network entities such as a network controller, a mobility management entity, or the like, and embodiments of the present disclosure are not limited in this regard.

It may be understood that in embodiments of the present disclosure, a device with communication functions in a network/system may be referred to as a “communication device”. Taking the communication system 100 illustrated in FIG. 1 as an example, the communication device may include the network device 110 and the terminal device(s) 120 that have communication functions. The network device 110 and the terminal device(s) 120 can be the devices described above and will not be repeated herein. The communication device may further include other devices such as a network controller, a mobility management entity, or other network entities in the communication system 100, and embodiments of the present disclosure are not limited in this regard.

It may be understood that, the terms “system” and “network” herein are usually used interchangeably throughout this disclosure. The term “and/or” herein only describes an association relationship between associated objects, which means that there can be three relationships. For example, A and/or B can mean A alone, both A and B exist, and B alone. In addition, the character “/” herein generally indicates that the associated objects are in an “or” relationship.

Terms used in implementations of the present disclosure are merely intended for explaining embodiments of the present disclosure rather than limiting the present disclosure. The terms “first”, “second”, “third”, “fourth”, and the like used in the specification, the claims, and the accompanying drawings of the present disclosure are used to distinguish different objects rather than describe a particular order. In addition, the terms “include”, “comprise”, and “have” as well as variations thereof, are intended to cover non-exclusive inclusion.

It may be understood that, “indication” referred to in embodiments of the present disclosure may be a direct indication, may be an indirect indication, or may mean that there is an association relationship. For example, A indicates B may mean that A directly indicates B, for instance, B can be obtained according to A; may mean that A indirectly indicates B, for instance, A indicates C, and B can be obtained according to C; or may mean that there is an association relationship between A and B.

In the elaboration of embodiments of the present disclosure, the term “correspondence” may mean that there is a direct or indirect correspondence between the two, may mean that there is an association relationship between the two, or may mean a relationship of indicating and being indicated or configuring and being configured, etc.

In embodiments of the present disclosure, the “pre-defined” or “preconfigured” can be implemented by pre-saving a corresponding code or table in a device (for example, including the terminal device and the network device) or in other manners that can be used for indicating related information, and the present disclosure is not limited in this regard. For example, the “pre-defined” may mean defined in a protocol.

In embodiments of the present disclosure, the “protocol” may refer to a communication standard protocol, which may be, for example, an evolution of an existing LTE protocol, NR protocol, Wi-Fi protocol, or a protocol related to other communication systems, and the present disclosure is not limited in this regard.

For a better understanding of embodiments of the present disclosure, a neural network and machine learning (ML) related to the present disclosure will be described.

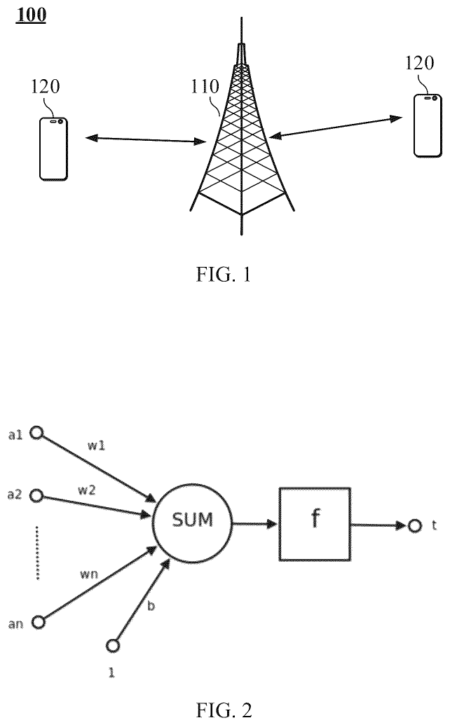

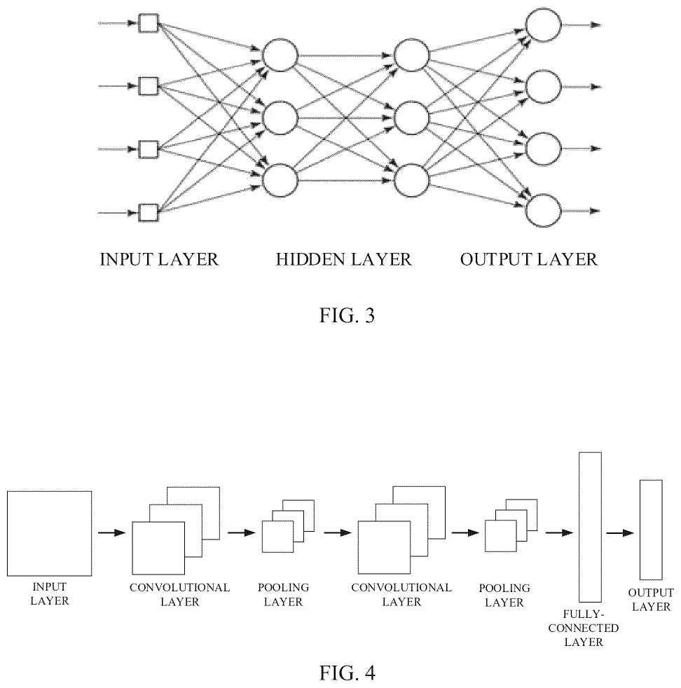

A neural network is a computational model consisting of multiple neuron nodes connected to one another. The connection between the nodes represents a weighted value from an input signal to an output signal, which is referred to as a weight. Each node performs weighted summation (SUM) on different input signals and outputs a result through a particular activation function (f). FIG. 2 is a schematic diagram of a neuron structure. A simple neural network is as illustrated in FIG. 3, which includes an input layer, a hidden layer, and an output layer. Different outputs may be generated through different connection methods, weights, and activation functions of multiple neurons, thereby fitting a mapping relationship from input to output.

Deep learning uses a deep neural network with multiple hidden layers, which greatly improves the network's feature learning capability and can fit a complex non-linear mapping from an input to an output, and thus, it is widely used in speech and image processing fields. In addition to the deep neural network, for different tasks, the deep learning further includes a CNN, a recurrent neural network (RNN), and other common basic structures.

A basic structure of a convolutional neural network includes an input layer, multiple convolutional layers, multiple pooling layers, a fully-connected layer, and an output layer, as illustrated in FIG. 4. Each neuron of a convolutional kernel in the convolutional layer is locally connected to its input, and the pooling layer is introduced to extract a local maximum value or average value feature of a certain layer, which effectively reduces parameters of the network and exploits local features, so that the convolutional neural network can achieve fast convergence and have excellent performance.

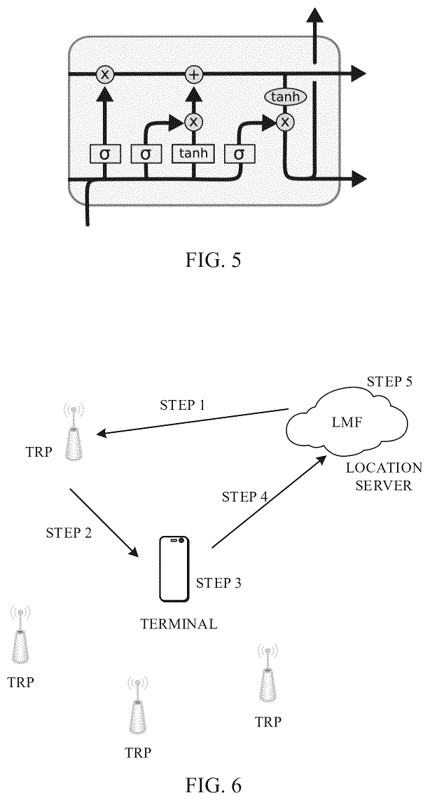

The RNN is a neural network that models sequence data, and has achieved remarkable accomplishments in the natural language processing field, for example, applications of machine translation and speech recognition. Specifically, a network memorizes information of a past moment and uses the information in calculation of a current output, that is, nodes between hidden layers are no longer unconnected but connected, and an input to a hidden layer includes not only an output of an input layer but also an output of a hidden layer at a previous moment. Common RNN includes structures such as long short-term memory (LSTM) and gated recurrent unit (GRU). FIG. 5 illustrates a basic structure of an LSTM unit, which may include a tanh activation function. Different from the RNN that considers only the most recent state, a cell state of the LSTM can determine which states may be retained and which states may be forgotten, thereby solving long-term memory limitations of the traditional RNN.

To facilitate a better understanding of embodiments of the present disclosure, positioning technologies in NR related to the present disclosure are explained.

Positioning methods in NR can be classified as follows.

UE-based positioning method: a terminal device directly calculates a location of a target device.

UE-assisted positioning method/location management function (LMF)-based positioning method: a terminal device reports a measurement result to an LMF entity, and the LMF entity calculates a location of a target device according to the collected measurement result.

Next-generation radio access network (NG-RAN) node-assisted positioning method: a base station reports a measurement result of a transmission reception point (TRP) to an LMF, and the LMF calculates a location of a target device according to the collected measurement result.

In traditional positioning methods, for different methods, a UE or an LMF applies traditional algorithms, such as Chan algorithm, Taylor expansion, and other algorithms to calculate a location of a target device.

To support various positioning methods, in the NR, a positioning reference signal (PRS) is introduced for DL, and a sounding reference signal (SRS) for positioning is introduced for UL.

The NR-based positioning function mainly involves three parts: a UE, multiple TRPs, and a location server. Multiple TRPs around a UE participate in cellular positioning. One base station may be one TRP, and one base station may have multiple TRPs. The location server is responsible for an entire positioning process, and the location server often includes an LMF entity.

A DL-based positioning method can be further classified into two categories: a UE-assisted positioning method and a UE-based positioning method.

Specifically, in the UE-assisted positioning method, a UE is responsible for a positioning-related measurement. A network calculates location information according to a measurement result reported by the UE.

Specifically, in the UE-based positioning method, a UE performs positioning-related measurement and calculates location information according to a measurement result.

In some embodiments, a basic process is described by taking a DL-based positioning method (the UE-assisted positioning method) as an example. As illustrated in FIG. 6, the method may specifically include Step 1 to Step 5 as follows.

Step 1, a location server notifies TRP-related configuration, where the TRP-related configuration may include configuration information for PRS, and/or a type of a measurement result required to be reported by a UE.

Step 2, a TRP sends a positioning signal PRS.

Step 3, the UE receives the positioning signal PRS and performs measurement, where the measurement result required by the UE is different with a different positioning method.

Step 4, the UE feeds back the measurement result to the location server, where the UE feeds back the measurement result to the location server via a base station.

Step 5, the location server calculates location-related information.

Specifically, FIG. 6 is a schematic process of a UE-assisted positioning method. For the UE-based positioning method, at Step 4, the UE calculates the location-related information directly according to the measurement result, and is not required to report the measurement result to the location server for the network element to calculate. In the UE-based positioning method, the UE is required to know location information corresponding to the TRP, and therefore, the network needs to notify the UE of the location information corresponding to the TRP in advance.

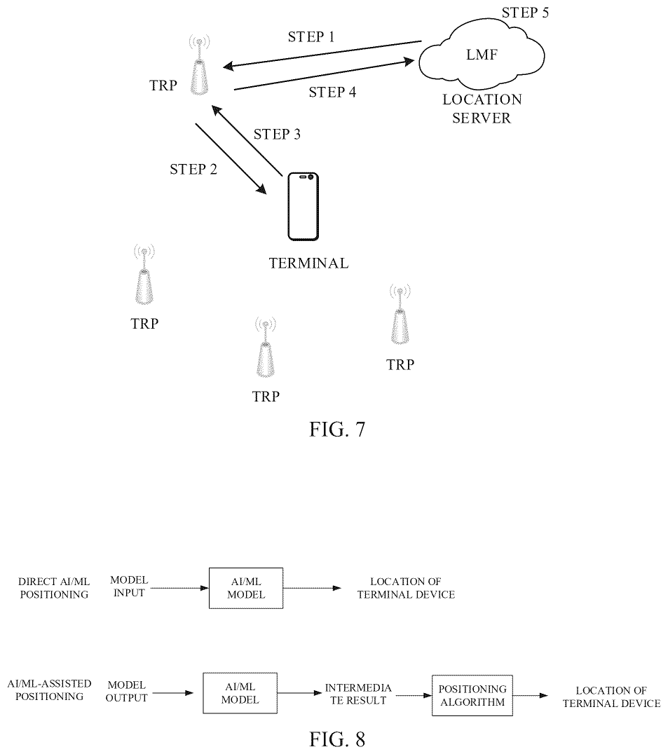

In some embodiments, a basis process is described by taking a UL-based positioning method as an example. As illustrated in FIG. 7, the method may specifically include Step 1 to Step 5 as follows.

Step 1, a location server notifies TRP-related configuration.

Step 2, a base station sends related signaling to a UE.

Step 3, the UE sends a UL signal (SRS for positioning).

Step 4, the TRP measures the SRS for positioning, and sends a measurement result to the location server.

Step 5, the location server calculates location-related information.

To facilitate a better understanding of embodiments of the present disclosure, an AI-based positioning method related to the present disclosure is described.

In the 3GPP, AI-based positioning enhancement is a widely discussed research project. In the AI-based positioning method, a potential mapping relationship between input information of a model and a location of a terminal device is extracted, and a large amount of labeled data is used for training, such that the positioning accuracy of the model can be significantly improved in a fixed environment. An AI/ML model may be combined with a positioning method in the NR to replace traditional algorithms, to estimate a location of a terminal device, thereby improving the positioning accuracy. The AI/ML model may be deployed at a UE side, may be deployed at an LMF side, or may be deployed at both the UE side and the LMF side. The combination of the AI/ML model and the positioning method may be classified into direct AI/ML positioning and AI/ML-assisted positioning. Specifically, as illustrated in FIG. 8, a model input for direct AI-based positioning is generally a measurement signal(s), such as a channel impulse response (CIR), a power delay profile (PDP), etc. An AI model output is the location of the terminal device. For the AI-assisted positioning, the model input is the same, but the output is an intermediate result(s), such as a downlink time of arrival (DL TOA), a downlink time difference of arrival (DL TDOA), or line of sight (LoS)/non line of sight (NLoS) identification result between the terminal device and multiple base stations. Then, the location of the terminal device can be further obtained by the terminal device or the LMF entity by utilizing the intermediate result(s) and positioning algorithms in the NR.

In order to facilitate a better understanding of embodiments of the present disclosure, the problem to be solved in the present disclosure is explained.

Disadvantages of the NR positioning method are as follows. The positioning method in the existing NR system relies on LoS paths between a terminal device and multiple base stations and calculates the location of the terminal device based on a geometric relationship. However, in an environment with a severe NLoS condition, such as a typical indoor factory environment, a probability of the LoS path between the terminal device and the base station is extremely low. As a result, performance of the positioning method based on a geometric relationship in the NR is extremely poor, and a positioning error in horizontal direction fails to meet actual requirements.

Disadvantages of the AI-based positioning method are as follows. Although the AI-based positioning method can achieve centimeter-level positioning accuracy in horizontal direction, the AI-based positioning method also has significant problems. Due to the limited generalization performance of the AI model, the AI-based positioning method can only be applied to relatively fixed scenarios. For example, when a wireless environment in a space changes, an original AI model may no longer adapt, leading to a decrease in positioning performance. However, in the AI-based positioning problems, it is difficult to obtain accurate positioning information, such as a location of the terminal device, a DL TDOA, and other data, during an actual deployment. As a result, it is impossible to monitor and verify the effectiveness of the AI model. How to monitor the accuracy of AI-based positioning is a technical problem to be solved.

Based on the above problems, a solution for monitoring prediction performance of a positioning model is proposed in the present disclosure. During model monitoring, an exact location of a terminal device is not required, and the performance of the positioning model can be monitored after output information of the positioning model is obtained, and thus ensuring the positioning accuracy of the positioning model.

For a better understanding of the technical solutions of embodiments of the present disclosure, the technical solutions of embodiments of the present disclosure will be elaborated below. The related art below, as an optional scheme, can be arbitrarily combined with the technical solutions of embodiments of the present disclosure, which shall all belong to the protection scope of embodiments of the present disclosure. Embodiments of the present disclosure include at least part of the following.

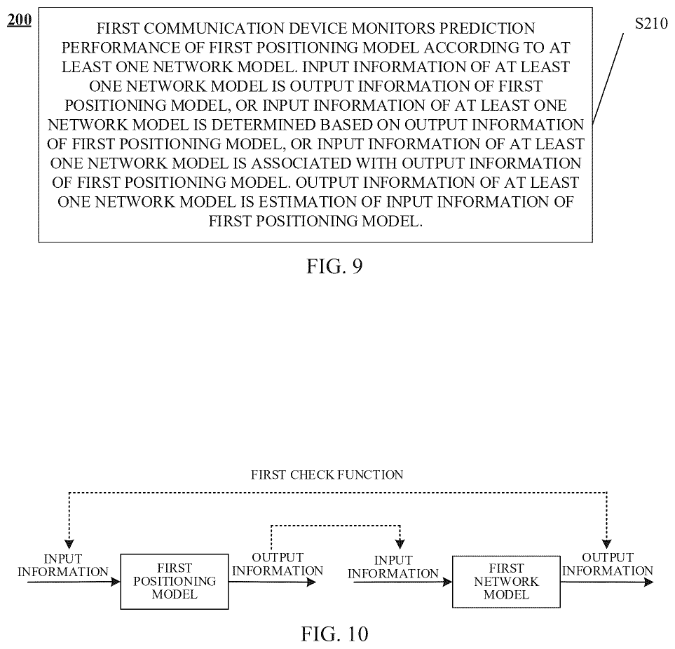

FIG. 9 is a schematic flowchart of a method 200 for wireless communication according to embodiments of the present disclosure. As illustrated in FIG. 9, the method 200 for wireless communication may include at least part of the following.

At S210, a first communication device monitors prediction performance of a first positioning model according to at least one network model, where input information of the at least one network model is output information of the first positioning model, or the input information of the at least one network model is determined based on the output information of the first positioning model, or the input information of the at least one network model is associated with the output information of the first positioning model. Output information of the at least one network model is an estimation of input information of the first positioning model.

In embodiments of the present disclosure, the first positioning model is used to implement positioning of a terminal device.

In embodiments of the present disclosure, the first communication device can monitor the prediction performance of the first positioning model according to the at least one network model. During model monitoring, an exact location of a terminal device is not required, and the performance of the first positioning model can be monitored after the output information of the first positioning model is obtained, and thus ensuring the positioning accuracy of the first positioning model.

In embodiments of the present disclosure, the input information of the at least one network model is the output information of the first positioning model, or the input information of the at least one network model is determined based on the output information of the first positioning model, or the input information of the at least one network model is associated with the output information of the first positioning model. That is, the at least one network model is a dual model of the first positioning model.

It may be noted that, the network model in embodiments of the present disclosure can be an AI/ML model.

In embodiments of the present disclosure, when a prediction result of the first positioning model is inaccurate, operations such as model switching, online model updating, etc., need to be performed.

In some embodiments, the “first positioning model” in embodiments of the present disclosure may also be replaced by a network model for implementing other functions (such as channel state information (CSI) feedback, beam prediction, etc.), which is not limited in embodiments of the present disclosure.

In some embodiments, the first communication device is a terminal device.

In some embodiments, the first communication device is a network device, for example, an LMF entity, an access network (AN) device (e.g., a base station).

In some embodiments, the input information of the first positioning model includes, but is not limited to, at least one of: a CIR, a channel PDP, a DL TOA, or a DL TDOA.

In some embodiments, the output information of the first positioning model includes, but is not limited to, at least one of: location information of a terminal device, a DL TOA, or a DL TDOA.

It may be noted that, in two-dimensional positioning, the location information of the terminal device generally refers to a two-dimensional vector composed of horizontal coordinates (x, y) of the terminal device, and in three-dimensional positioning, the location information of the terminal device generally refers to a three-dimensional vector composed of three-dimensional coordinates (x, y, z) of the terminal device.

In some embodiments, when the number of the at least one network model is greater than or equal to 2, a different network model is implemented with a different model architecture. For example, one network model is implemented with a fully-connected network model architecture, while another network model is implemented with a convolutional neural network model architecture. In embodiments of the present disclosure, different dual model architectures are used, such that the probability that all the at least one network model produces false detection can be reduced, thereby improving the model monitoring accuracy of the dual models.

In some embodiments, the at least one network model includes a first network model. That is, the first network model is a dual model of the first positioning model. Input information of the first network model is the output information of the first positioning model, or the input information of the first network model is determined based on the output information of the first positioning model (e.g., the input information of the first network model is obtained by performing quantization, with a certain accuracy, on the output information of the first positioning model), or the input information of the first network model is associated with the output information of the first positioning model. Output information of the first network model is an estimation of the input information of the first positioning model.

In some embodiments, the operations at S210 may specifically include the following. The first communication device monitors the prediction performance of the first positioning model according to a check value obtained by performing check with a first check function, where the check value corresponding to the first check function is used for reflecting a similarity between the output information of the first network model and the input information of the first positioning model.

Specifically, as illustrated in FIG. 10, the check value corresponding to the first check function is used for reflecting the similarity between the output information of the first network model and the input information of the first positioning model.

In this embodiment, the prediction performance of the first positioning model can be monitored based on the dual model (i.e., the first network model) without requiring the true location of the terminal device as a reference. By utilizing a forward mapping relationship and a reverse mapping relationship between the location of the terminal device and the input information of the first positioning model, the accuracy of the first positioning model can be estimated through the dual model (i.e., the first network model).

Specifically, for example, the input information of the first positioning model is a CIR (denoted as h₁), and the output information of the first network model is an estimation of the CIR, denoted as h₂. The first network model is referred to as a dual model of the first positioning model. The first network model is used to extract a mapping relationship from the location information of the terminal device (the input information of the first network model) to channel information (the output information of the first network model), which actually simulates a channel generation process in a positioning model using an AI method, and can be considered a type of AI-based channel generator. Specifically, the first check function is defined as r(h₁, h₂). The check value corresponding to the first check function is used for reflecting the similarity between the output information of the first network model and the input information of the first positioning model.

In some embodiments, the first check function may be configured to calculate the check value using metrics such as a mean square error (MSE), a normalized mean square error (NMSE), a cosine similarity (CS), etc. Alternatively, the first check function is a pre-trained AI function that can output the check value when the output information of the first network model and the input information of the first positioning model are input.

In some embodiments, in the case where the check value obtained by performing check with the first check function is greater than or equal to a first threshold, the first communication device determines that a prediction result of the first positioning model is accurate. Additionally/alternatively, in the case where the check value obtained by performing check with the first check function is less than the first threshold, the first communication device determines that the prediction result of the first positioning model is inaccurate.

That is, in the embodiment, when the check value obtained by performing check with the first check function is greater than or equal to the first threshold, it is considered that the output information of the first network model is highly consistent with the input information of the first positioning model. In this case, it means that the output information of the first positioning model (that is, positioning coordinates) has a relatively small error relative to the actual location of the terminal device, and the first positioning model can operate normally in the current environment. When the check value obtained by performing check with the first check function is less than the first threshold, it is considered that the output information of the first network model has low consistency with the input information of the first positioning model. In this case, it means that the output information of the first positioning model (that is, the positioning coordinates) has a relatively large error relative to the actual location of the terminal device, that is, the positioning accuracy is relatively low. As such, it is considered that the positioning accuracy of the first positioning model fails to meet the requirement, and operations such as model switching, online model updating, etc., need to be performed.

In some embodiments, in the case where a value obtained by performing filtering on multiple check values obtained within a first duration by performing check with the first check function is greater than or equal to the first threshold, the first communication device determines that the prediction result of the first positioning model is accurate. Additionally/alternatively, in the case where the value obtained by performing filtering on the multiple check values obtained within the first duration by performing check with the first check function is less than the first threshold, the first communication device determines that the prediction result of the first positioning model is inaccurate.

Optionally, performing filtering on the multiple check values obtained within the first duration by performing check with the first check function includes the following. A mean of the multiple check values obtained by performing check with the first check function within the first duration is calculated. Alternatively, a weighted mean of the multiple check values obtained by performing check with the first check function within the first duration is calculated.

Alternatively, a mean of the multiple check values obtained by performing check with the first check function within the first duration, after removing the maximum value and/or the minimum value, is calculated. Alternatively, a weighted mean of the multiple check values obtained by performing check with the first check function within the first duration, after removing the maximum value and/or the minimum value, is calculated.

Certainly, the filtering process in embodiments of the present disclosure may also be implemented through other filtering algorithms, which is not limited in the present disclosure.

In some embodiments, in the case where each of multiple check values obtained by performing check with the first check function within the first duration is greater than or equal to the first threshold, the first communication device determines that the prediction result of the first positioning model is accurate. Additionally/alternatively, in the case where at least one of the multiple check values obtained by performing check with the first check function within the first duration is less than the first threshold, the first communication device determines that the prediction result of the first positioning model is inaccurate.

In some embodiments, in the case where a probability that the multiple check values obtained by performing check with the first check function within the first duration are greater than or equal to the first threshold is greater than or equal to a second threshold, the first communication device determines that the prediction result of the first positioning model is accurate. Additionally/alternatively, in the case where the probability that the multiple check values obtained by performing check with the first check function within the first duration are greater than or equal to the first threshold is less than the second threshold, the first communication device determines that the prediction result of the first positioning model is inaccurate.

It may be noted that, the first duration may also be referred to as “first time window” or a similar name, which is not limited in the present disclosure.

In some embodiments, the first threshold is defined by a protocol, or the first threshold is configured by a network device.

In some embodiments, the second threshold is defined by a protocol, or the second threshold is configured by a network device.

In some embodiments, as Example 1, the first communication device is an LMF entity, the first network model is deployed at an LMF entity side, and the first positioning model is deployed at a terminal device side.

Optionally, in Example 1, the first network model is a network model at cell granularity, and the first positioning model is a network model at terminal granularity. In other words, since the first positioning model is deployed at the terminal device side, it is considered that the first positioning model is terminal-specific, i.e., a different terminal device can use a different positioning model to implement the positioning function. Since the first network model is deployed at the LMF entity side, the first network model is cell-specific, and the first network model can monitor a different positioning model of a different terminal device.

Specifically, when the first positioning model is deployed at the terminal device side and the first network model is deployed at the LMF entity side, the LMF entity monitors and manages the first positioning model. In this case, the output information of the first positioning model is quantized and then fed back by the terminal device to the LMF entity side, and is de-quantized at the LMF entity side to obtain the input information of the first network model.

In order for the LMF entity side to monitor the first positioning model, the terminal device can also feed back the input information of the first positioning model to the LMF entity side. The input information of the first positioning model is used by the LMF entity to calculate a check function (i.e., the first check function) between the input information of the first positioning model and the output information of the first network model, determine whether the check value obtained by performing check with the first check function reaches the first threshold, and then monitor the prediction performance of the first positioning model (i.e., determining the availability of the first positioning model). Specifically, the input information of the first positioning model and the output information of the first positioning model can be fed back via first feedback information.

Optionally, in Example 1, the first communication device receives first feedback information sent by the terminal device, where the first feedback information includes the input information of the first positioning model and/or the output information of the first positioning model.

In Example 1, the terminal device may periodically send the first feedback information (i.e., periodic monitoring feedback), or the terminal device may be triggered to aperiodically send the first feedback information (i.e., triggered aperiodic monitoring feedback).

Specifically, the first communication device may obtain the input information of the first network model based on the output information of the first positioning model, and the first communication device may determine a check value based on the input information of the first positioning model.

Optionally, the first feedback information may be carried in at least one of: radio resource control (RRC) signaling, a media access control control element (MAC CE), or uplink control information (UCI).

Optionally, in Example 1, before the first communication device receives the first feedback information, the first communication device sends first configuration information to the terminal device. The first configuration information is used for configuring at least one of: a feedback format of the input information of the first positioning model, feedback, by the terminal device, of the input information of the first positioning model within (corresponding to) the first duration, a feedback format of the output information of the first positioning model, or feedback, by the terminal device, of the output information of the first positioning model within (corresponding to) the first duration.

Optionally, in Example 1, in the case where the first feedback information is information sent periodically, the first configuration information is further used for configuring period information for the terminal device to feed back the input information of the first positioning model and/or the output information of the first positioning model.

Specifically, for periodic monitoring feedback, after the terminal device accesses the network, the LMF entity configures, via the first configuration information, feedback period T for the first feedback information and time window length W (i.e., the first duration) of each feedback period, the feedback format of the input information of the first positioning model, and the feedback format of the output information of the first positioning model, for example, a quantization manner, an effective length of the input information of the first positioning model, etc. For example, when the input information of the first positioning model is a CIR, the effective length of the input information of the first positioning model may include the following aspects.
a: in the time dimension, only the first N1 paths of the CIR can be configured for feedback reporting.
b: in the spatial dimension, only the N2 TRPs with the highest power can be configured for feedback reporting
c: in both the time and spatial dimensions, only the first N1 paths of the N2 TRPs with the highest power can be configured for feedback reporting.
d: other possible manners such as truncation and extraction of the first input information.

The first configuration information is configured by the LMF entity and indicated to the terminal device via DL signaling. The signaling may be an RRC, an MAC CE, or downlink control information (DCI) signaling, or may be dedicated DL signaling for model monitoring and management. With periodic monitoring feedback, after the LMF entity completes the configuration for the terminal device once, parameters such as {T, W, N1, N2} are determined, and the terminal device can periodically send the first feedback information according to the parameters until the LMF entity updates the first configuration information via DL signaling subsequently.

Optionally, the first configuration information may be carried in at least one of: RRC signaling, an MAC CE, or DCI.

Optionally, in Example 1, for triggered aperiodic monitoring feedback, the first configuration information is further used for triggering the terminal device to feed back the input information of the first positioning model and/or the output information of the first positioning model. Specifically, when the aperiodic monitoring feedback is triggered by the LMF entity side, the LMF entity can directly trigger model monitoring by sending the first configuration information to the terminal device. Similarly, the first configuration information does not contain feedback period T, but only contains parameters such as {W, N1, N2}. After the LMF entity receives the first feedback information, the LMF entity performs check and filtering, with the first network model, on the feedback information obtained within time window W, and indicates a monitoring result of the first positioning model to the terminal device.

Optionally, in Example 1, for triggered aperiodic monitoring feedback, before the first communication device sends the first configuration information, the first communication device receives a first model monitoring request sent by the terminal device. The first model monitoring request is used to request monitoring of the prediction performance of the first positioning model, and the first model monitoring request triggers the first communication device to send the first configuration information. Specifically, when the aperiodic monitoring feedback is triggered by the terminal device side, the terminal device can trigger the LMF entity to send the first configuration information via the first model monitoring request, where the first configuration information does not contain feedback period T, but only contains parameters such as {W, N1, N2}. The first model monitoring request may be carried in UL signaling, such as UCI, or other dedicated UL signaling for model monitoring and management. After the LMF entity receives the first feedback information, the LMF entity performs check and filtering, with the first network model, on the feedback information obtained within time window W, and indicates a monitoring result of the first positioning model to the terminal device.

Optionally, in Example 1, for triggered aperiodic monitoring feedback, the first communication device sends first monitoring information to the terminal device, where the first monitoring information indicates that the prediction result of the first positioning model is inaccurate, or the first monitoring information indicates whether the prediction result of the first positioning model is accurate. Specifically, after the LMF entity completes the monitoring of the first positioning model deployed at the terminal device side, the LMF entity indicates to the terminal device via DL signaling whether the first positioning model used for AI positioning in the terminal device is applicable to the current environment and whether the positioning result of the first positioning model used for AI positioning is reliable. When it is indicated that the first positioning model is unreliable, schemes such as model switching, model updating, etc., can be further considered.

Optionally, in Example 1, for periodic monitoring feedback, the first communication device periodically sends second monitoring information to the terminal device, where the second monitoring information indicates whether the prediction result of the first positioning model is accurate within a corresponding period. Specifically, after the LMF entity completes the monitoring of the first positioning model deployed at the terminal device side, the LMF entity indicates to the terminal device via DL signaling whether the first positioning model used for AI positioning in the terminal device is applicable to the current environment and whether the positioning result of the first positioning model used for AI positioning is reliable. When it is indicated that the first positioning model is unreliable, schemes such as model switching, model updating, etc., can be further considered.

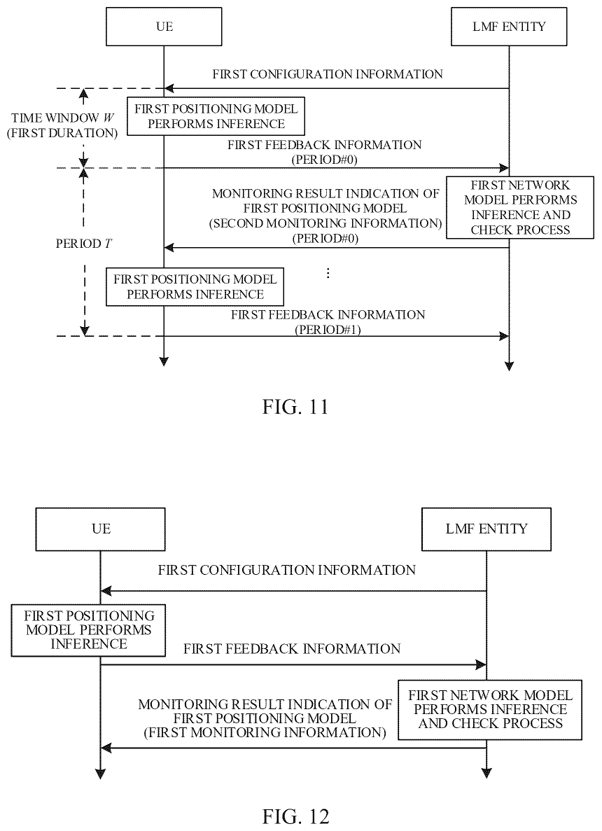

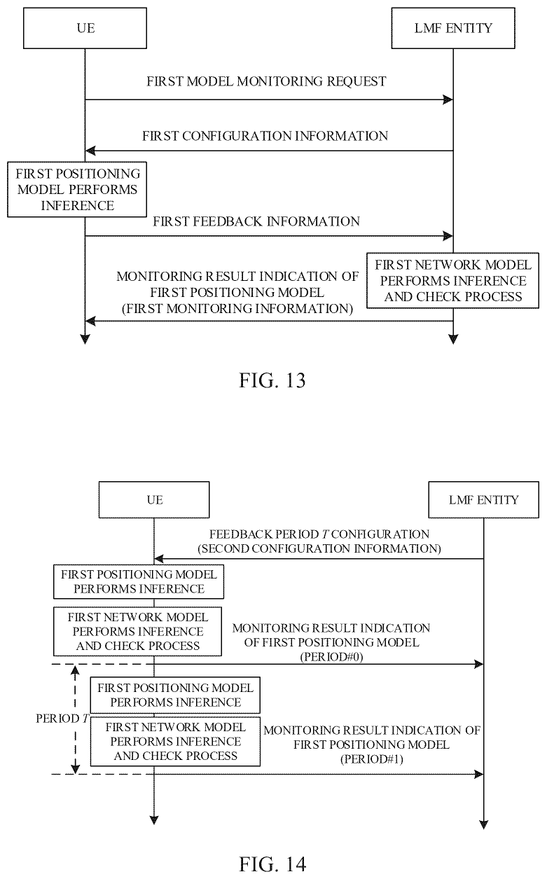

In Example 1, for periodic monitoring feedback, FIG. 11 is a flowchart illustrating signalling of periodic monitoring feedback by an LMF entity. For aperiodic monitoring feedback triggered by the LMF entity, FIG. 12 is a flowchart illustrating signalling of aperiodic monitoring feedback triggered by an LMF entity. For aperiodic monitoring feedback triggered by the terminal device, FIG. 13 is a flowchart illustrating signalling of aperiodic monitoring feedback triggered by a terminal device.

In some embodiments, as Example 2, the first communication device is an LMF entity, and both the first network model and the first positioning model are deployed at the LMF entity side.

In Example 2, when both the first network model and the first positioning model are deployed at an LMF entity side, the input information of the first positioning model required for the positioning function of the first positioning model is measured and fed back by the terminal device. Since the first network model is also deployed at the LMF entity side, the input information of the first positioning model and the output information of the first positioning model that are used for model monitoring can be obtained directly at the LMF entity side, without a need for additional reporting from the terminal device.

Optionally, in Example 2, both the first network model and the first positioning model are network models at cell granularity. Specifically, the first positioning model at the LMF entity side is cell-specific, that is, multiple terminal devices in the current environment share the first positioning model for positioning. The first network model is also cell-specific, such that a monitoring result of the first positioning model by the first network model is also applicable to all terminal devices in the cell. The monitoring result of the first network model in this case can be obtained by performing filtering on check values over an extended period for different terminal devices.

Optionally, in Example 2, the first communication device sends third monitoring information, where the third monitoring information indicates that the prediction result of the first positioning model is inaccurate.

Optionally, in Example 2, the prediction performance of the first positioning model is monitored periodically, or the prediction performance of the first positioning model is monitored aperiodically.

Optionally, in Example 2, in the case where the prediction performance of the first positioning model is monitored periodically, a monitoring period for the prediction performance of the first positioning model is defined by a protocol, or the monitoring period for the prediction performance of the first positioning model is determined by the first communication device.

In Example 2, when the monitoring result of the first positioning model at the LMF entity side meets the requirement, the LMF entity may not make any indication to the terminal device. In this case, the terminal device assumes, by default, that the first positioning model is operating normally and the positioning accuracy meets the requirement. When the monitoring result of the first positioning model at the LMF entity side does not meet the requirement, the LMF entity indicates to the terminal device via DL signaling that the positioning accuracy of the first positioning model at the LMF entity side does not meet the requirement. The monitoring process is determined by the LMF entity side, and can be triggered by the LMF entity periodically or aperiodically. The monitoring process is not available at the terminal device side. In some embodiments, as Example 3, the first communication device is a terminal device, and both the first network model and the first positioning model are deployed at a terminal device side.

In Example 3, when both the first network model and the first positioning model are deployed at the terminal device side, the input information of the first positioning model required for the positioning function of the first positioning model is measured and obtained by the terminal device. Here, since the first network model is also deployed at the terminal device side, the input information of the first positioning model and the output information of the first positioning model that are used for model monitoring can be obtained directly at the terminal device side.

Optionally, in Example 3, both the first network model and the first positioning model are network models at terminal granularity. Specifically, the first positioning model at the terminal device side is terminal-specific. Since the first network model is also deployed at the terminal device side, the first network model is also terminal-specific. A different terminal device can use a different implementation. Therefore, the monitoring result of the first positioning model by the first network model is only applicable to a corresponding terminal device.

In Example 3, the model monitoring process at the terminal device side is configured by the LMF entity, and is performed in a periodic or aperiodic manner.

Optionally, in Example 3, the first communications device sends fourth monitoring information, where the fourth monitoring information indicates that the prediction result of the first positioning model is inaccurate, or the fourth monitoring information indicates whether the prediction result of the first positioning model is accurate. In other words, in this example, the terminal device can autonomously send the fourth monitoring information without requiring configuration by the network (e.g., by the LMF entity).

Optionally, the fourth monitoring information may be carried in at least one of: RRC signaling, UCI, or an MAC CE.

Optionally, in Example 3, the first communication device receives second configuration information, where the second configuration information indicates that the first communication device is to periodically monitor the prediction performance of the first positioning model, or the second configuration information indicates that the first communication device is to aperiodically monitor the prediction performance of the first positioning model.

Optionally, the second configuration information may be carried in at least one of: RRC signaling, DCI, or an MAC CE.

Optionally, in Example 3, in the case where the second configuration information indicates that the first communication device is to periodically monitor the prediction performance of the first positioning model, the second configuration information includes period information for the first communication device to monitor the prediction performance of the first positioning model, or the period information for the first communication device to monitor the prediction performance of the first positioning model is defined by a protocol, or the period information for the first communication device to monitor the prediction performance of the first positioning model is determined by the first communication device.

Optionally, in Example 3, the first communication device sends fifth monitoring information, where the fifth monitoring information indicates whether the prediction result of the first positioning model is accurate within a corresponding period.

Optionally, the fifth monitoring information may be carried in at least one of: RRC signaling, UCI, or an MAC CE.

Optionally, in Example 3, in the case where the second configuration information indicates that the first communication device is to aperiodically monitor the prediction performance of the first positioning model, the second configuration information includes first time offset information, where the first time offset information indicates a time at which the first communication device reports a monitoring result of the prediction performance of the first positioning model after receiving the second configuration information.

Optionally, in Example 3, the first communication device sends sixth monitoring information according to the first time offset information, where the sixth monitoring information indicates whether the prediction result of the first positioning model is accurate.

Optionally, the sixth monitoring information may be carried in at least one of: RRC signaling, UCI, or an MAC CE.

For example, in Example 3, for periodic monitoring feedback, after the terminal device accesses the network, the LMF entity configures feedback period T for the monitoring result of the model via the second configuration information. During the period, the input information of the first positioning model and the output information of the first network model, obtained through local measurement by the terminal device, are checked with the first check function, to obtain multiple check results. In this configuration, time window W (i.e., the first duration) for the terminal device to monitor may be uniformly configured by the LMF entity via DL signaling. Alternatively, when the time window is not configured by the LMF entity, the time window may be determined by the terminal device according to a default value(s) or its own implementation. Time window W (i.e., the first duration) only determines how many outputs of the first network model and how many check results are filtered to obtain the final monitoring result of the terminal device, and does not affect the feedback overhead on the air interface. At the end of period T, the terminal device reports the monitoring result of the model corresponding to the period to the LMF entity. When the monitoring result indicates that the positioning accuracy of the model at the terminal device side does not meet the requirement, the LMF entity can instruct the terminal device to perform and assist the terminal device in performing operations such as model switching or model updating. The specific signaling process is as illustrated in FIG. 14.

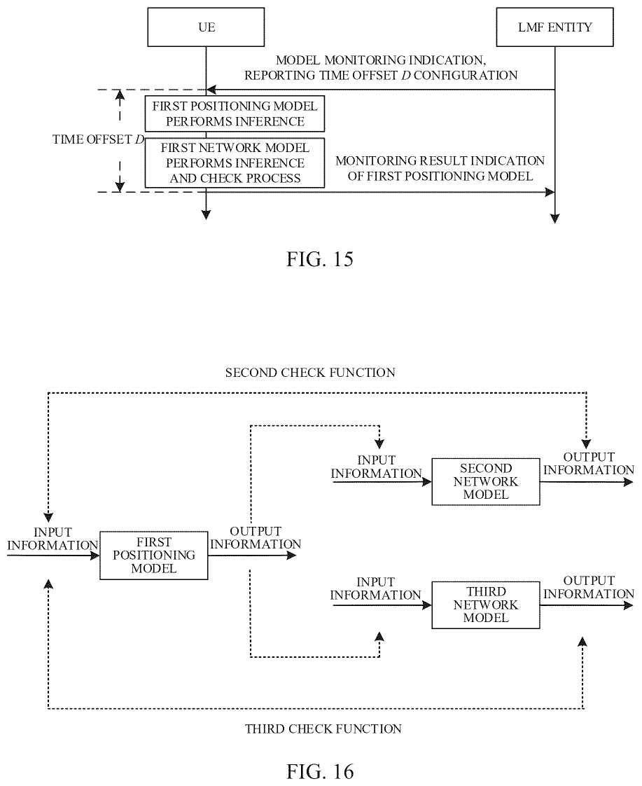

For example, in Example 3, for triggered aperiodic monitoring feedback, the aperiodic monitoring feedback can be triggered by the LMF entity or the terminal device side. When the aperiodic monitoring feedback is triggered by the terminal device side, the terminal device can directly monitor the first positioning model locally with the first network model, and report the result to the LMF entity side. When the aperiodic monitoring feedback triggered by the LMF entity side, the LMF entity instructs the terminal device to perform model monitoring via DL signaling and report the monitoring result of the model. Reporting time offset D for the monitoring result of the model is also indicated in the DL signaling, that is, the terminal device reports the monitoring result of the model in the I-th time unit after receiving the model monitoring indication. In this example, the monitoring result of the model is obtained by performing filtering on multiple check results within time window W by the first network model at the terminal device side. Time window W may be configured by the LMF entity together with reporting time offset D in the DL signaling, where W<=D. Alternatively, time window W may not be configured by the LMF entity, and the terminal device may adopt a default time window W=D or may determine time window W depending on terminal device implementation. The specific signaling process triggered by the LMF entity side is as illustrated in FIG. 15.

In some embodiments, the at least one network model includes a second network model and a third network model, where the second network model and the third network model have different model architectures. For example, the second network model adopts a fully-connected network model architecture, and the third network model adopts a convolutional neural network model architecture. In this embodiment, both the second network model and the third network model are dual models of the first positioning model. Input information of the second network model is the output information of the first positioning model, or the input information of the second network model is determined based on the output information of the first positioning model (e.g., the input information of the second network model is obtained by performing quantization, with a certain accuracy, on the output information of the first positioning model), or the input information of the second network model is associated with the output information of the first positioning model. Output information of the second network model is an estimation of the input information of the first positioning model. Input information of the third network model is the output information of the first positioning model, or the input information of the third network model is determined based on the output information of the first positioning model (e.g., the input information of the third network model is obtained by performing quantization, with a certain accuracy, on the output information of the first positioning model), or the input information of the third network model is associated with the output information of the first positioning model. Output information of the third network model is an estimation of the input information of the first positioning model.

In this embodiment, both the second network model and the third network model are dual models of the first positioning model. Based on the setting of two dual models, there is no need to obtain the exact location of the terminal device as a reference. By adopting dual model architectures with different implementations as much as possible, the probability that both the second network model and the third network model produce false detection is reduced, thereby improving the monitoring accuracy of the dual models. Compared with the solution in which one dual model (i.e., the first network model) is adopted, this approach can avoid the poor check performance caused by unstable performance of the first network model, thereby reducing the possibility of inaccurate monitoring of the first positioning model.

In some embodiments, the operations at S210 may specifically include the following. The first communication device monitors the prediction performance of the first positioning model according to a check value obtained by performing check with a second check function and a check value obtained by performing check with a third check function. The check value corresponding to the second check function is used for reflecting a similarity between the output information of the second network model and the input information of the first positioning model. The check value corresponding to the third check function is used for reflecting a similarity between the output information of the third network model and the input information of the first positioning model.

Specifically, as illustrated in FIG. 16, the check value corresponding to the second check function is used for reflecting the similarity between the output information of the second network model and the input information of the first positioning model, and the check value corresponding to the third check function is used for reflecting a similarity between the output information of the third network model and the input information of the first positioning model.

Specifically, for example, the input information of the first positioning model is a CIR (denoted as w₁), and both the output information of the second network model and the output information of the third network model are estimations of the CIR, denoted as w₂ and w₃, respectively. Both the second network model and the third network model are referred to as the dual models of the first positioning model, and are used to extract a mapping relationship from the location information of the terminal device (the input information of the second network model and the input information of the third network model) to channel information (the output information of the second network model and the output information of the third network model), which actually simulates a channel generation process in a positioning model using the AI method, and can be considered a type of AI-based channel generator. Specifically, the second check function is defined as r(w₁, w₂) and the third check function is defined as r(w₁, w₃). The check value corresponding to the second check function is used for reflecting the similarity between the output information of the second network model and the input information of the first positioning model. The check value corresponding to the third check function is used for reflecting the similarity between the output information of the third network model and the input information of the first positioning model.

In some embodiments, the second check function may be configured to calculate the check value using metrics such as an MSE, an NMSE, a CS, etc. Alternatively, the second check function is a pre-trained AI function that can output the check value when the output information of the second network model and the input information of the first positioning model are input. In some embodiments, the third check function may be configured to calculate the check value using metrics such as an MSE, an NMSE, a CS, etc. Alternatively, the third check function is a pre-trained AI function that can output the check value when the output information of the third network model and the input information of the first positioning model are input.

In some embodiments, in the case where a mean of the check value corresponding to the second check function and the check value corresponding to the third check function is greater than or equal to the first threshold, the first communication device determines that the prediction result of the first positioning model is accurate. Additionally/alternatively, in the case where the mean of the check value corresponding to the second check function and the check value corresponding to the third check function is less than the first threshold, the first communication device determines that the prediction result of the first positioning model is inaccurate.

That is, in the embodiment, when the mean of the check value obtained by performing check with the second check function and the check value obtained by performing check with the third check function is greater than or equal to the first threshold, it is considered that the output information of the second network model is highly consistent with the input information of the first positioning model, and that the output information of the third network model is also highly consistent with the input information of the first positioning model. In this case, it indicates that the output information of the first positioning model (i.e., positioning coordinates) has a relatively small error relative to the actual location of the terminal device, and the first positioning model can operate normally in the current environment. When the mean of the check value obtained by performing check with the second check function and the check value obtained by performing check with the third check function is less than the first threshold, it is considered that the output information of the second network model has low consistency with the input information of the first positioning model, and that the output information of the third network model has low consistency with the input information of the first positioning model. In this case, it indicates that the output information of the first positioning model (i.e., the positioning coordinates) has a relatively large error relative to the actual location of the terminal device, that is, the positioning accuracy is relatively low. As such, it is considered that the positioning accuracy of the first positioning model fails to meet the requirement, and operations such as model switching, online model updating, etc., need to be performed.

In some embodiments, in the case where a mean of a value obtained by performing filtering on multiple check values obtained by performing check with the second check function within the first duration and a value obtained by performing filtering on multiple check values obtained by performing check with the third check function within the first duration is greater than or equal to the first threshold, the first communication device determines that the prediction result of the first positioning model is accurate. Additionally/alternatively, in the case where the mean of the value obtained by performing filtering on the multiple check values obtained by performing check with the second check function within the first duration and the value obtained by performing filtering on the multiple check values obtained by performing check with the third check function within the first duration is less than the first threshold, the first communication device determines that the prediction result of the first positioning model is inaccurate.

Optionally, performing filtering on the multiple check values obtained by performing check with the second check function within the first duration includes the following. A mean of the multiple check values obtained by performing check with the second check function within the first duration is calculated. Alternatively, a weighted mean of the multiple check values obtained by performing check with the second check function within the first duration is calculated. Alternatively, a mean of the multiple check values obtained by performing check with the second check function within the first duration, after removing the maximum value and/or the minimum value, is calculated. Alternatively, a weighted mean of the multiple check values obtained by performing check with the second check function within the first duration, after removing the maximum value and/or the minimum value, is calculated.

Optionally, performing filtering on the multiple check values obtained by performing check with the third check function within the first duration includes the following. A mean of the multiple check values obtained by performing check with the third check function within the first duration is calculated. Alternatively, a weighted mean of the multiple check values obtained by performing check with the third check function within the first duration is calculated. A mean of the multiple check values obtained by performing check with the third check function within the first duration, after removing the maximum value and/or the minimum value, is calculated. Alternatively, a weighted mean of the multiple check values obtained by performing check with the third check function within the first duration, after removing the maximum value and/or the minimum value, is calculated.

Certainly, the filtering process in embodiments of the present disclosure may also be implemented through other filtering algorithms, which is not limited in the present disclosure.

In some embodiments, in the case where a mean of multiple check values obtained by performing check with the second check function within the first duration and multiple check values obtained by performing check with the third check function within the first duration is greater than or equal to the first threshold, the first communication device determines that the prediction result of the first positioning model is accurate. Additionally/alternatively, in the case where the mean of the multiple check values obtained by performing check with the second check function within the first duration and the multiple check values obtained by performing check with the third check function within the first duration is less than the first threshold, the first communication device determines that the prediction result of the first positioning model is inaccurate.

In some other embodiments, the operations at S210 may specifically include the following. The first communication device monitors the prediction performance of the first positioning model according to a check value obtained by performing check with a fourth check function, where the check value corresponding to the fourth check function is used for reflecting a similarity between output information of the second network model and output information of the third network model.

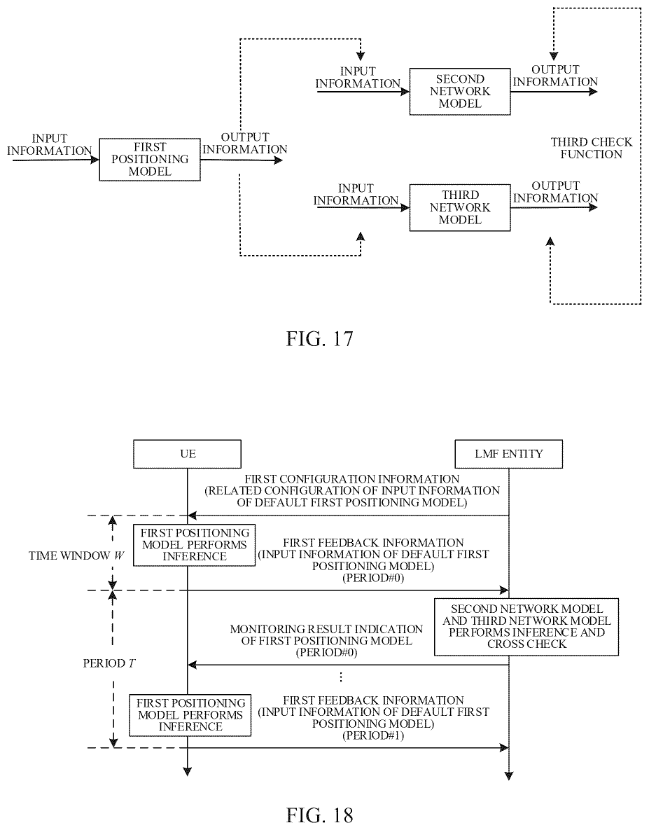

Specifically, as illustrated in FIG. 17, the check value corresponding to the fourth check function is used for reflecting the similarity between output information of the second network model and output information of the third network model. In other words, the first communications device can monitor the prediction performance of the first positioning model by checking the similarity between the output information of the second network model and the output information of the third network model, without obtaining the input information of the first positioning model.

For example, both the output information of the second network model and the output information of the third network model are estimations of the input information of the first positioning model, denoted as s₁ and s₂, respectively. Specifically, the fourth check function is defined as r(s₁, s₂), and the check value corresponding to the fourth check function is used for reflecting the similarity between the output information of the second network model and the output information of the third network model. The fourth check function can be understood as a cross-check function. The cross-check function r(s₁, s₂) is used for calculating the similarity between the output information of the second network model and the output information of the third network model, and a check result of the cross-check function indicates the monitoring result of the first positioning model.

In some embodiments, the fourth check function may be configured to calculate the check value using metrics such as an MSE, an NMSE, a CS, etc. Alternatively, the fourth check function is a pre-trained AI function that can output the check value when the output information of the second network model and the output information of the third network model are input.

In some embodiments, in the case where the check value obtained by performing check with the fourth check function is greater than or equal to a third threshold, the first communication device determines that the prediction result of the first positioning model is accurate. Additionally/alternatively, in the case where the check value obtained by performing check with the fourth check function is less than the third threshold, the first communication device determines that the prediction result of the first positioning model is inaccurate.

In some embodiments, in the case where a value obtained by performing filtering on multiple check values obtained by performing check with the fourth check function within the first duration is greater than or equal to the third threshold, the first communication device determines that the prediction result of the first positioning model is accurate.

Additionally/alternatively, in the case where the value obtained by performing filtering on the multiple check values obtained by performing check with the fourth check function within the first duration is less than the third threshold, the first communication device determines that the prediction result of the first positioning model is inaccurate.

Optionally, performing filtering on the multiple check values obtained by performing check with the fourth check function within the first duration includes the following. A mean of the multiple check values obtained by performing check with the fourth check function within the first duration is calculated. Alternatively, a weighted mean of the multiple check values obtained by performing check with the fourth check function within the first duration is calculated. Alternatively, a mean of the multiple check values obtained by performing check with the fourth check function within the first duration, after removing the maximum value and/or the minimum value, is calculated. Alternatively, a weighted mean of the multiple check values obtained by performing check with the fourth check function within the first duration, after removing the maximum value and/or the minimum value, is calculated.

Certainly, the filtering process in embodiments of the present disclosure may also be implemented through other filtering algorithms, which is not limited in the present disclosure.

In some embodiments, in the case where each of multiple check values obtained by performing check with the fourth check function within the first duration is greater than or equal to the third threshold, the first communication device determines that the prediction result of the first positioning model is accurate. Additionally/alternatively, in the case where at least one of the multiple check values obtained by performing check with the fourth check function within the first duration is less than the third threshold, the first communication device determines that the prediction result of the first positioning model is inaccurate.

In some embodiments, in the case where a probability that multiple check values obtained by performing check with the fourth check function within the first duration are greater than or equal to the third threshold is greater than or equal to a fourth threshold, the first communication device determines that the prediction result of the first positioning model is accurate. Additionally/alternatively, in the case where the probability that the multiple check values obtained by performing check with the fourth check function within the first duration are greater than or equal to the third threshold is greater than or equal to the fourth threshold, the first communication device determines that the prediction result of the first positioning model is inaccurate.

In some embodiments, the third threshold is defined by a protocol, or the third threshold is configured by a network device.

In some embodiments, the fourth threshold is defined by a protocol, or the fourth threshold is configured by a network device.

In some embodiments, as Example 4, the first communication device is an LMF entity, both the second network model and the third network model are deployed at an LMF entity side, and the first positioning model is deployed at a terminal device side.

In Example 4, the first communication device monitors the prediction performance of the first positioning model according to the check value obtained by performing check with the second check function and the check value obtained by performing check with the third check function. Additionally/alternatively, the first communication device monitors the prediction performance of the first positioning model according to the check value obtained by performing check with the fourth check function.

Optionally, in Example 4, both the second network model and the third network model are network models at cell granularity, and the first positioning model is a network model at terminal granularity. In other words, since the first positioning model is deployed at the terminal device side, it is considered that the first positioning model is terminal-specific, i.e., a different terminal device can use a different positioning model to implement the positioning function. Since both the second network model and the third network model are deployed at the LMF entity side, both the second network model and the third network model are cell-specific, and the second network model and the third network model can monitor a different positioning model of a different terminal device.

Specifically, when the first positioning model is deployed at the terminal device side and both the second network model and the third network model are deployed at the LMF entity side, the LMF entity monitors and manages the first positioning model. In this case, the output information of the first positioning model is quantified and then fed back by the terminal device to the LMF entity side, and is de-quantized at the LMF entity side to obtain the input information of the second network model and the input information of the third network model.

In the case where the first communication device monitors the prediction performance of the first positioning model according to the check value obtained by performing check with the second check function and the check value obtained by performing check with the third check function, in order for the LMF entity side to monitor the first positioning model, the terminal device can also feed back the input information of the first positioning model to the LMF entity side. The input information of the first positioning model is used by the LMF entity to calculate a check function (i.e., the second check function) between the input information of the first positioning model and the output information of the second network model and a check function (i.e., the third check function) between the input information of the first positioning model and the output information of the third network model, determine whether the mean of the check value obtained by performing check with the second check function and the check value obtained by performing check with the third check function reaches the first threshold, and then monitor the prediction performance of the first positioning model (i.e., determining the availability of the first positioning model). Specifically, the input information of the first positioning model and the output information of the first positioning model can be fed back via the first feedback information.

Optionally, in Example 4, the first communication device receives first feedback information sent by the terminal device, where the first feedback information includes the input information of the first positioning model and/or the output information of the first positioning model.

Specifically, for example, in the case where the first communication device can monitor the prediction performance of the first positioning model according to the check value obtained by performing check with the second check function and the check value obtained by performing check with the third check function, the first feedback information includes the input information of the first positioning model and the output information of the first positioning model.

Specifically, for example, in the case where the first communication device monitors the prediction performance of the first positioning model according to the check value obtained by performing check with the fourth check function, the first feedback information can only include the output information of the first positioning model.

In Example 4, the terminal device may periodically send the first feedback information (i.e., periodic monitoring feedback), or the terminal device may be triggered to aperiodically send the first feedback information (i.e., triggered aperiodic monitoring feedback).

Optionally, in Example 4, before the first communication device receives the first feedback information, the first communication device sends first configuration information to the terminal device, where the first configuration information is used for configuring at least one of: a feedback format of the input information of the first positioning model, feedback, by the terminal device, of the input information of the first positioning model corresponding to the first duration, a feedback format of the output information of the first positioning model, or feedback, by the terminal device, of the output information of the first positioning model corresponding to the first duration.

For example, in the case where the first communication device can monitor the prediction performance of the first positioning model according to the check value obtained by performing check with the second check function and the check value obtained by performing check with the third check function, the first configuration information is used for configuring at least one of: a feedback format of the input information of the first positioning model, feedback, by the terminal device, of the input information of the first positioning model corresponding to the first duration, a feedback format of the output information of the first positioning model, or feedback, by the terminal device, of the output information of the first positioning model corresponding to the first duration.

For example, in the case where the first communication device monitors the prediction performance of the first positioning model according to the check value obtained by performing check with the fourth check function, the first configuration information is used for configuring at least one of: a feedback format of the output information of the first positioning model, or feedback, by the terminal device, of the output information of the first positioning model corresponding to the first duration.

Optionally, in Example 4, in the case where the first feedback information is information sent periodically, the first configuration information is further used for configuring period information for the terminal device to feed back the input information of the first positioning model and/or the output information of the first positioning model.

Specifically, for periodic monitoring feedback, after the terminal device accesses the network, the LMF entity configures, via the first configuration information, feedback period T for the first feedback information and time window length W (i.e., the first duration) of each feedback period, the feedback format of the input information of the first positioning model, and the feedback format of the output information of the first positioning model, for example, a quantization manner, an effective length of the input information of the first positioning model, etc. For example, when the input information of the first positioning model is a CIR, the effective length of the input information of the first positioning model may include the following aspects.
a: in the time dimension, only the first N1 paths of the CIR can be configured for feedback reporting.
b: in the spatial dimension, only the N2 TRPs with the highest power can be configured for feedback reporting.
c: in both the time and spatial dimensions, only the first N1 paths of the N2 TRPs with the highest power can be configured for feedback reporting.
d: other possible manners such as truncation and extraction of the first input information.

The first configuration information is configured by the LMF entity and indicated to the terminal device via DL signaling. The signaling may be an RRC, an MAC CE, or downlink control information (DCI) signaling, or may be dedicated DL signaling for model monitoring and management. With periodic monitoring feedback, after the LMF entity completes the configuration for the terminal device once, parameters such as {T, W, N1, N2} are determined, and the terminal device can periodically send the first feedback information according to the parameters until the LMF entity updates the first configuration information via DL signaling subsequently.

Optionally, the first configuration information may be carried in at least one of: RRC signaling, an MAC CE, or DCI.

Optionally, in Example 4, for triggered aperiodic monitoring feedback, the first configuration information is further used for triggering the terminal device to feedback the input information of the first positioning model and/or the output information of the first positioning model. Specifically, when the aperiodic monitoring feedback is triggered by the LMF entity side, the LMF entity can directly trigger model monitoring by sending the first configuration information to the terminal device. Similarly, the first configuration information does not contain feedback period T, but only contains parameters such as {W, N1, N2}. After the LMF entity receives the first feedback information, the LMF entity performs check and filtering, with the first network model, on the feedback information obtained within time window W, and indicates a monitoring result of the first positioning model to the terminal device.

Optionally, in Example 4, for triggered aperiodic monitoring feedback, before the first communication device sends the first configuration information, the first communication device receives a first model monitoring request sent by the terminal device. The first model monitoring request is used to request monitoring of the prediction performance of the first positioning model, and the first model monitoring request triggers the first communication device to send the first configuration information. Specifically, when the aperiodic monitoring feedback is triggered by the terminal device side, the terminal device can trigger the LMF entity to send the first configuration information via the first model monitoring request, where the first configuration information does not contain feedback period T, but only contains parameters such as {W, N1, N2}. The first model monitoring request may be carried in UL signaling, such as UCI, or other dedicated UL signaling for model monitoring and management. After the LMF entity receives the first feedback information, the LMF entity performs check and filtering, with the first network model, on the feedback information obtained within time window W, and indicates a monitoring result of the first positioning model to the terminal device.

Optionally, in Example 4, for triggered aperiodic monitoring feedback, the first communication device sends first monitoring information to the terminal device, where the first monitoring information indicates that the prediction result of the first positioning model is inaccurate, or the first monitoring information indicates whether the prediction result of the first positioning model is accurate. Specifically, after the LMF entity completes the monitoring of the first positioning model deployed at the terminal device side, the LMF entity indicates to the terminal device via DL signaling whether the first positioning model used for AI positioning in the terminal device is applicable to the current environment and whether the positioning result of the first positioning model used for AI positioning is reliable. When it is indicated that the first positioning model is unreliable, schemes such as model switching, model updating, etc., can be further considered.

Optionally, in Example 4, for periodic monitoring feedback, the first communication device periodically sends second monitoring information to the terminal device, where the second monitoring information indicates whether the prediction result of the first positioning model is accurate within a corresponding period.

Specifically, for example, both the second network model and the third network model are deployed at the LMF entity side, and the first positioning model is deployed at the terminal device side. In the case where the first communication device can monitor the prediction performance of the first positioning model according to the check value obtained by performing check with the fourth check function (a cross-check function), the first feedback information can only include the output information of the first positioning model. A specific signaling interaction process of the LMF entity periodically monitoring the prediction performance of the first positioning model can be as illustrated in FIG. 18.

In some embodiments, as Example 5, the first communication device is an LMF entity, and the second network model, the third network model, and the first positioning model are all deployed at an LMF entity side.

In Example 5, the first communication device monitors the prediction performance of the first positioning model according to the check value obtained by performing check with the second check function and the check value obtained by performing check with the third check function. Additionally/alternatively, the first communication device monitors the prediction performance of the first positioning model according to the check value obtained by performing check with the fourth check function.

In Example 5, when the second network model, the third network model, and the first positioning model are all deployed at the LMF entity side, the input information of the first positioning model required for the positioning function of the first positioning model is measured and fed back by the terminal device. Since both the second network model and the third network model are also deployed at the LMF entity side, the input information of the first positioning model and/or the output information of the first positioning model that are used for model monitoring can be obtained directly at the LMF entity side, without a need for additional reporting from the terminal device.

Optionally, in Example 5, the second network model, the third network model, and the first positioning model are all network models at cell granularity. Specifically, the first positioning model at the LMF entity side is cell-specific, that is, multiple terminal devices in the current environment share the first positioning model for positioning. Both the second network model and the third network model are also cell-specific, such that monitoring results of the first positioning model by the second network model and the third network model are also applicable to all terminal devices in the cell. The monitoring results of the second network model and the third network model in this case can be obtained by performing filtering on check values over an extended period for different terminal devices.

Optionally, in Example 5, the first communication device sends third monitoring information, where the third monitoring information indicates that the prediction result of the first positioning model is inaccurate.

Optionally, in Example 5, the prediction performance of the first positioning model is monitored periodically, or the prediction performance of the first positioning model is monitored aperiodically.

Optionally, in Example 5, in the case where the prediction performance of the first positioning model is monitored periodically, a monitoring period for the prediction performance of the first positioning model is defined by a protocol, or the monitoring period for the prediction performance of the first positioning model is determined by the first communication device. In Example 5, when the monitoring result of the first positioning model at the LMF entity side meets the requirement, the LMF entity may not make any indication to the terminal device. In this case, the terminal device assumes, by default, that the first positioning model is operating normally and the positioning accuracy meets the requirement. When the monitoring result of the first positioning model at the LMF entity side does not meet the requirement, the LMF entity indicates to the terminal device via DL signaling that the positioning accuracy of the first positioning model at the LMF entity side does not meet the requirement. The monitoring process is determined by the LMF entity side, and can be triggered by the LMF entity periodically or aperiodically. The monitoring process is not available at the terminal device side.

In some embodiments, as Example 6, the first communication device is a terminal device, and the second network model, the third network model, and the first positioning model are all deployed at a terminal device side.

In Example 6, the first communication device monitors the prediction performance of the first positioning model according to the check value obtained by performing check with the second check function and the check value obtained by performing check with the third check function. Additionally/alternatively, the first communication device monitors the prediction performance of the first positioning model according to the check value obtained by performing check with the fourth check function.

In Example 6, when the second network model, the third network model, and the first positioning model are all deployed at the terminal device side, the input information of the first positioning model required for the positioning function of the first positioning model is measured and obtained by the terminal device. Since both the second network model and the third network model are also deployed at the terminal device side, the input information of the first positioning model and/or the output information of the first positioning model that are used for model monitoring can be obtained directly at the terminal device side.

Optionally, in Example 6, the second network model, the third network model, and the first positioning model are all network models at terminal granularity. Specifically, the first positioning model at the terminal device side is terminal-specific. Since both the second network model and the third network model are also deployed at the terminal device side, the second network model and the third network model are also terminal-specific. A different terminal device can use a different implementation. Therefore, the monitoring results of the first positioning model using the second network model and the third network model are only applicable to corresponding terminal devices.

In Example 6, the model monitoring process at the terminal device side is configured by the LMF entity, and is performed in a periodic or aperiodic manner.

Optionally, in Example 6, the first communications device sends fourth monitoring information, where the fourth monitoring information indicates that the prediction result of the first positioning model is inaccurate, or the fourth monitoring information indicates whether the prediction result of the first positioning model is accurate. In other words, in this example, the terminal device can autonomously send the fourth monitoring information without requiring configuration by the network (e.g., by the LMF entity).

Optionally, in Example 6, the first communication device receives second configuration information, where the second configuration information indicates that the first communication device is to periodically monitor the prediction performance of the first positioning model, or the second configuration information indicates that the first communication device is to aperiodically monitor the prediction performance of the first positioning model.

Optionally, in Example 6, in the case where the second configuration information indicates that the first communication device is to periodically monitor the prediction performance of the first positioning model, the second configuration information includes period information for the first communication device to monitor the prediction performance of the first positioning model, or the period information for the first communication device to monitor the prediction performance of the first positioning model is defined by a protocol, or the period information for the first communication device to monitor the prediction performance of the first positioning model is determined by the first communication device.

Optionally, in Example 6, the first communication device sends fifth monitoring information, where the fifth monitoring information indicates whether the prediction result of the first positioning model is accurate within a corresponding period.

Optionally, in Example 6, in the case where the second configuration information indicates that the first communication device is to aperiodically monitor the prediction performance of the first positioning model, the second configuration information includes first time offset information, where the first time offset information indicates a time at which the first communication device reports a monitoring result of the prediction performance of the first positioning model after receiving the second configuration information.

Optionally, in Example 6, the first communication device sends sixth monitoring information according to the first time offset information, where the sixth monitoring information indicates whether the prediction result of the first positioning model is accurate.

For example, in Example 6, for periodic monitoring feedback, after the terminal device accesses the network, the LMF entity configures feedback period T for the monitoring result of the model via the second configuration information. During the period, the input information of the first positioning model, the output information of the second network model, and the output information of the third network model that are obtained through local measurement by the terminal device are checked with the second function and the third check function, to obtain multiple check results. Alternatively, during the period, the output information of the second network model and the output information of the third network model, obtained through local measurement by the terminal device, are checked with the fourth check function, to obtain multiple check results. In this configuration, time window W (i.e., the first duration) for the terminal device to monitor may be uniformly configured by the LMF entity via DL signaling. Alternatively, when the time window is not configured by the LMF entity, the time window may be determined by the terminal device according to a default value(s) or its own implementation. Time window W (i.e., the first duration) only determines how many outputs of the second network model and the third network model and how many check results are filtered to obtain the final monitoring result of the terminal device, and does not affect the feedback overhead on the air interface. At the end of period T, the terminal device reports the monitoring result of the model corresponding the period to the LMF entity. When the monitoring result indicates that the positioning accuracy of the model at the terminal device side does not meet the requirement, the LMF entity can instruct the terminal device to perform and assist the terminal device in performing operations such as model switching or model updating.

For example, in Example 6, for triggered aperiodic monitoring feedback, the aperiodic monitoring feedback can be triggered by the LMF entity or the terminal device side. When the aperiodic monitoring feedback is triggered by the terminal device side, the terminal device can directly monitor the first positioning model locally with the second network model and the third network model, and report the results to the LMF entity side. When the aperiodic monitoring feedback is triggered by the LMF entity side, the LMF entity instructs the terminal device to perform model monitoring via DL signaling and report the monitoring results of the models. Reporting time offset D for the monitoring result of the model is also indicated in the DL signaling, that is, the terminal device reports the monitoring result of the model in the D-th time unit after receiving the model monitoring indication. In this example, the monitoring results of the models are obtained by performing filtering on multiple check results within time window W by the second network model and the third network model at the terminal device side. Time window W may be configured by the LMF entity together with reporting time offset D in the DL signaling, where W<=D. Alternatively, time window W may not be configured by the LMF entity, and the terminal device may adopt a default time window W=D or may determine time window W depending on terminal device implementation.

In some embodiments, the at least one network model includes a second network model and a third network model, where the second network model and the third network model have different model architectures, both the second network model and the first positioning model are deployed at a terminal device side, the third network model is deployed at an LMF entity side, and the first communication device is an LMF entity.

In this embodiment, both the second network model and the third network model are dual models of the first positioning model. Based on the setting of two dual models, there is no need to obtain the accurate location of the terminal device as a reference. By adopting dual model architectures with different implementations as much as possible, the probability that both the second network model and the third network model produce false detection is reduced, thereby improving the monitoring accuracy of the dual models. Compared with the solution in which one dual model (i.e., the first network model) is adopted, this approach can avoid the poor check performance caused by unstable performance of the first network model, thereby reducing the possibility of inaccurate monitoring of the first positioning model.

In some embodiments, the operations at S210 may specifically include the following. The first communication device monitors the prediction performance of the first positioning model according to check information corresponding to the second check function and the check value corresponding to the third check function. The check information corresponding to the second check function is obtained from the terminal device. The check information corresponding to the second check function includes the check value corresponding to the second check function, or the check information corresponding to the second check function includes a monitoring result of the first positioning model determined based on the check value corresponding to the second check function. The check value corresponding to the second check function is used for reflecting the similarity between the output information of the second network model and the input information of the first positioning model. The check value corresponding to the third check function is used for reflecting the similarity between the output information of the third network model and the input information of the first positioning model.

Specifically, for example, the check information corresponding to the second check function includes the check value corresponding to the second check function, that is, the terminal device may directly report a check result of the second network model to the LMF entity or may perform reporting to the LMF entity after quantizing the check result of the second network model.

Specifically, for example, the check information corresponding to the second check function includes a monitoring result of the first positioning model determined based on the check value corresponding to the second check function. For example, the terminal device adds a 1-bit indication field into UCI to indicate whether the prediction result of the first positioning model determined at the terminal device side is accurate.

In some embodiments, the second check function may be configured to calculate the check value using metrics such as an MSE, an NMSE, a CS, etc. Alternatively, the second check function is a pre-trained AI function that can output the check value when the output information of the second network model and the input information of the first positioning model are input.

In some embodiments, the third check function may be configured to calculate the check value using metrics such as an MSE, an NMSE, a CS, etc. Alternatively, the third check function is a pre-trained AI function that can output the check value when the output information of the third network model and the input information of the first positioning model are input.

In other words, in this embodiment, a terminal device that can perform model monitoring reports both the second feedback information (containing the input information of the first positioning model and the output information of the first positioning model) and the monitoring result of the second network model to the LMF entity. The LMF entity determines whether the prediction result of the first positioning model is accurate based on the monitoring result reported by the terminal device and the monitoring result calculated by the third network model at the LMF entity.

In some embodiments, in the case where the check information corresponding to the second check function includes the check value corresponding to the second check function, the first communication device monitors the prediction performance of the first positioning model according to the check information corresponding to the second check function and the check value corresponding to the third check function as follows. In the case where a mean of the check value corresponding to the second check function and the check value corresponding to the third check function is greater than or equal to the first threshold, the first communication device determines that the prediction result of the first positioning model is accurate.

Additionally/alternatively, in the case where the mean of the check value corresponding to the second check function and the check value corresponding to the third check function is less than the first threshold, the first communication device determines that the prediction result of the first positioning model is inaccurate.

In some embodiments, in the case where the check information corresponding to the second check function includes the monitoring result of the first positioning model determined based on the check value corresponding to the second check function, the first communication device monitors the prediction performance of the first positioning model according to the check information corresponding to the second check function and the check value corresponding to the third check function as follows. The first communication device determines the monitoring result of the first positioning model determined based on the check value corresponding to the second check function as a final monitoring result, or the first communication device determines a monitoring result of the first positioning model determined based on the check value corresponding to the third check function as the final monitoring result. In the case where the check value corresponding to the second check function is greater than or equal to the first threshold, the monitoring result of the first positioning model indicates that the prediction result of the first positioning model is accurate; and/or in the case where the check value corresponding to the second check function is less than the first threshold, the monitoring result of the first positioning model indicates that the prediction result of the first positioning model is inaccurate. In the case where the check value corresponding to the third check function is greater than or equal to the first threshold, the monitoring result of the first positioning model indicates that the prediction result of the first positioning model is accurate; and/or in the case where the check value corresponding to the third check function is less than the first threshold, the monitoring result of the first positioning model indicates that the prediction result of the first positioning model is inaccurate.

Specifically, in the case where the check information corresponding to the second check function includes the monitoring result of the first positioning model determined based on the check value corresponding to the second check function, whether the LMF entity determines the monitoring result of the first positioning model determined based on the check value corresponding to the second check function as the final monitoring result or determines the monitoring result of the first positioning model determined based on the check value corresponding to the third check function as the final monitoring result may be determined by the LMF based on its implementation, or may be determined according to an indication from another core network (CN) network element. Preferably, the LMF entity determines the monitoring result of the first positioning model determined based on the check value corresponding to the third check function as the final monitoring result.

In some embodiments, the first communication device receives the check information corresponding to the second check function and second feedback information that are sent by the terminal device, where the second feedback information includes the input information of the first positioning model and the output information of the first positioning model.

Optionally, the check information corresponding to the second check function and the second feedback information may be reported via the same signaling or different signaling, which is not limited in the present disclosure.

In some embodiments, the second feedback information is carried in one of: RRC signaling, UCI, or an MAC CE.

In some embodiments, before the first communication device receives the second feedback information, the first communication device sends third configuration information to the terminal device, where the third configuration information is used for configuring at least one of: content contained in the check information corresponding to the second check function, a feedback format of the input information of the first positioning model, or a feedback format of the output information of the first positioning model.

In some embodiments, the third configuration information is carried in one of: RRC signaling, DCI, or an MAC CE.

In some embodiments, the third configuration information is further used for triggering the terminal device to feed back the input information of the first positioning model, the output information of the first positioning model, and the check information corresponding to the second check function.

In some embodiments, before the first communication device sends the third configuration information, the first communication device receives a second model monitoring request sent by the terminal device, where the second model monitoring request is used to request monitoring of the prediction performance of the first positioning model, and the second model monitoring request triggers the first communication device to send the third configuration information.

In some embodiments, the first communication device sends seventh monitoring information to the terminal device, where the seventh monitoring information indicates that the prediction result of the first positioning model is inaccurate, or the seventh monitoring information indicates whether the prediction result of the first positioning model is accurate.

In some embodiments, the seventh monitoring information is carried in one of: RRC signaling, DCI, or an MAC CE.

In some embodiments, the check information corresponding to the second check function and the second feedback information are information sent periodically. The third configuration information is further used for configuring at least one of: period information for the terminal device to feed back the input information of the first positioning model and the output information of the first positioning model, or period information for the terminal device to feed back the check information corresponding to the second check function.

In some embodiments, the first communication device periodically sends eighth monitoring information to the terminal device, where the eighth monitoring information indicates whether a prediction result of the first positioning model is accurate within a corresponding period.

In some embodiments, the eighth monitoring information is carried in one of: RRC signaling, DCI, or an MAC CE.

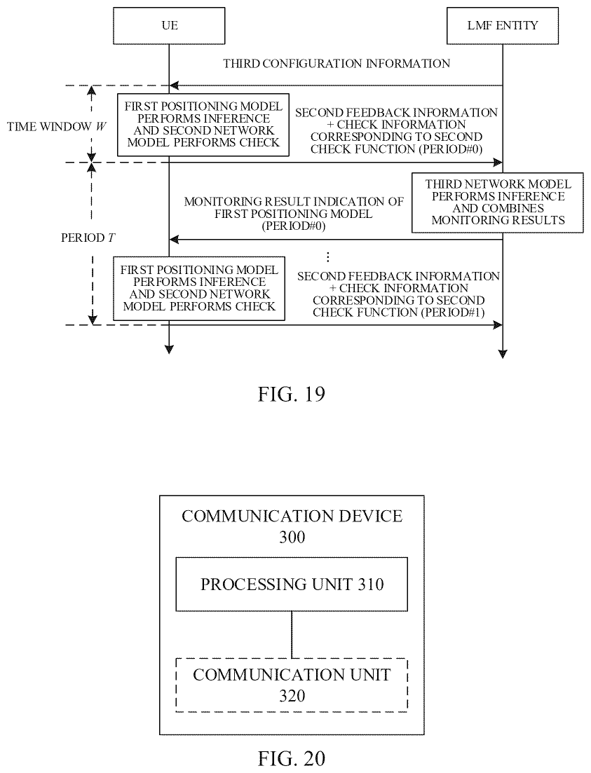

For example, for periodic monitoring feedback, when the monitoring result of the model at the terminal device is reported as a high-precision feedback (that is, the check information corresponding to the second check function includes the check value corresponding to the second check function), the LMF entity side obtains a final monitoring result of the model by combining and averaging the monitoring result of the model reported by the terminal device and the monitoring result of the model calculated locally by the LMF entity, and indicates the final monitoring result of the model to the terminal device via DL signaling. At the end of period T, the terminal device reports the monitoring result of the model in the period to the LMF entity. When the monitoring result indicates that the positioning accuracy of the model at the terminal device side does not meet the requirement, the LMF entity can instruct the terminal device to perform and assist the terminal device in performing operations such as model switching or model updating. The specific signaling process is as illustrated in FIG. 19. After the terminal device accesses the network, the LMF entity configures, via the third configuration information, at least one of: content contained in the check information corresponding to the second check function, a feedback format of the input information of the first positioning model, or a feedback format of the output information of the first positioning model.

In some embodiments, the at least one network model includes a second network model and a third network model, where the second network model and the third network model have different model architectures, both the second network model and the first positioning model are deployed at a terminal device side, the third network model is deployed at an LMF entity side, and the first communication device is an LMF entity. In this case, whether the prediction result of the first positioning model is accurate can be determined in a cross-check manner similar to the fourth check function. For details, reference may be made to the description of the fourth check function, which will not be repeated herein.

Therefore, in embodiments of the present disclosure, the first communication device can monitor the prediction performance of the first positioning model according to the at least one network model. During model monitoring, the exact location of the terminal device is not required, and the performance of the first positioning model can be monitored after the output information of the first positioning model is obtained, thereby ensuring the positioning accuracy of the first positioning model.

Specifically, in embodiments of the present disclosure, the solution for monitoring the positioning model based on a dual model is designed. In this solution, the dual model is deployed at the terminal device side or the LMF side, the mapping relationship between the location of the terminal device (i.e., the output information of the first positioning model) and the input information of the dual model is utilized, the similarity between the output of the dual model and the input of the positioning model is evaluated with a check function, and thus an error between the output of the positioning model and the actual location of terminal device can be measured.

Specifically, in embodiments of the present disclosure, the solution for monitoring the positioning model based on two dual models is designed. In this solution, two dual models with different implementation structures are deployed, and the monitoring results of the two positioning models are combined. As such, when the monitoring of the positioning model is implemented, a false detection rate of the dual model can be reduced, and the monitoring accuracy of the positioning model can be further improved. In this solution, the terminal device side and the LMF side can both perform model monitoring, and report and combine the monitoring results of the models, thereby further improving the accuracy of the model monitoring.

The main advantage of embodiments of the present disclosure is that the positioning accuracy of the AI model can be monitored without obtaining the exact location coordinates of the terminal device at the terminal device side or the LMF side. In this way, the cost of obtaining the location coordinates of the terminal device during the actual deployment process can be saved, and the model monitoring and management efficiency of the entire positioning system can be improved. In embodiments of the present disclosure, by means of designing corresponding information indications, feedback, and monitoring signaling processes, the periodic model monitoring method and the triggered aperiodic model monitoring method can be supported at both the terminal device side and the LMF side, such that the terminal device and LMF can more effectively monitor the positioning model and manage a subsequent lifecycle process according to actual conditions.

The method embodiments of the present disclosure are described in detail above with reference to FIG. 9 to FIG. 19, and apparatus embodiments of the present disclosure will be described in detail below with reference to FIG. 20 to FIG. 23. It may be understood that, the apparatus embodiments and the method embodiments correspond to each other, and for similar illustrations, reference may be made to the method embodiments.

FIG. 20 is a schematic block diagram of a communication device 300 according to embodiments of the present disclosure. The communication device 300 is a first communication device. As illustrated in FIG. 20, the communication device 300 includes a processing unit 310. The processing unit 310 is configured to monitor prediction performance of a first positioning model according to at least one network model. Input information of the at least one network model is output information of the first positioning model, or the input information of the at least one network model is determined based on the output information of the first positioning model, or the input information of the at least one network model is associated with the output information of the first positioning model. Output information of the at least one network model is an estimation of input information of the first positioning model.

In some embodiments, the at least one network model includes a first network model. The processing unit 310 is specifically configured to monitor the prediction performance of the first positioning model according to a check value obtained by performing check with a first check function. The check value corresponding to the first check function is used for reflecting a similarity between output information of the first network model and the input information of the first positioning model.

In some embodiments, the processing unit 310 is specifically configured to determine that a prediction result of the first positioning model is accurate in the case where the check value obtained by performing check with the first check function is greater than or equal to a first threshold. Additionally/alternatively, the processing unit 310 is specifically configured to determine that the prediction result of the first positioning model is inaccurate in the case where the check value obtained by performing check with the first check function is less than the first threshold.

In some embodiments, the processing unit 310 is specifically configured to determine that the prediction result of the first positioning model is accurate in the case where a value obtained by performing filtering on multiple check values obtained by performing check with the first check function within a first duration is greater than or equal to a first threshold. Additionally/alternatively, the processing unit 310 is specifically configured to determine that the prediction result of the first positioning model is inaccurate in the case where the value obtained by performing filtering on the multiple check values obtained by performing check with the first check function within the first duration is less than the first threshold.

In some embodiments, the processing unit 310 is specifically configured to determine that the prediction result of the first positioning model is accurate in the case where each of multiple check values obtained by performing check with the first check function within the first duration is greater than or equal to the first threshold, the first communication device. Additionally/alternatively, the processing unit 310 is specifically configured to determine that the prediction result of the first positioning model is inaccurate in the case where at least one of the multiple check values obtained by performing check with the first check function within the first duration is less than the first threshold.

In some embodiments, the processing unit 310 is specifically configured to determine that the prediction result of the first positioning model is accurate in the case where a probability that multiple check values obtained by performing check with the first check function within the first duration are greater than or equal to the first threshold is greater than or equal to a second threshold. Additionally/alternatively, the processing unit 310 is specifically configured to determine that the prediction result of the first positioning model is inaccurate in the case where the probability that the multiple check values obtained by performing check with the first check function within the first duration are greater than or equal to the first threshold is less than the second threshold.

In some embodiments, the at least one network model includes a second network model and a third network model, where the second network model and the third network model have different model architectures. The processing unit 310 is specifically configured to monitor the prediction performance of the first positioning model according to a check value obtained by performing check with a second check function and a check value obtained by performing check with a third check function. The check value corresponding to the second check function is used for reflecting a similarity between output information of the second network model and the input information of the first positioning model. The check value corresponding to the third check function is used for reflecting a similarity between output information of the third network model and the input information of the first positioning model.

In some embodiments, the processing unit 310 is specifically configured to determine that the prediction result of the first positioning model is accurate in the case where a mean of the check value corresponding to the second check function and the check value corresponding to the third check function is greater than or equal to the first threshold. Additionally/alternatively, the processing unit 310 is specifically configured to determine that the prediction result of the first positioning model is inaccurate in the case where the mean of the check value corresponding to the second check function and the check value corresponding to the third check function is less than the first threshold.

In some embodiments, the processing unit 310 is specifically configured to determine that the prediction result of the first positioning model is accurate in the case where a mean of a value obtained by performing filtering on multiple check values obtained by performing check with the second check function within the first duration and a value obtained by performing filtering on multiple check values obtained by performing check with the third check function within the first duration is greater than or equal to the first threshold. Additionally/alternatively, the processing unit 310 is specifically configured to determine that the prediction result of the first positioning model is inaccurate in the case where the mean of the value obtained by performing filtering on the multiple check values obtained by performing check with the second check function within the first duration and the value obtained by performing filtering on the multiple check values obtained by performing check with the third check function within the first duration is less than the first threshold.

In some embodiments, the processing unit 310 is specifically configured to determine that the prediction result of the first positioning model is accurate in the case where a mean of multiple check values obtained by performing check with the second check function within the first duration and multiple check values obtained by performing check with the third check function within the first duration is greater than or equal to the first threshold. Additionally/alternatively, the processing unit 310 is specifically configured to determine that the prediction result of the first positioning model is inaccurate in the case where the mean of the multiple check values obtained by performing check with the second check function within the first duration and the multiple check values obtained by performing check with the third check function within the first duration is less than the first threshold.

In some embodiments, the at least one network model includes a second network model and a third network model, where the second network model and the third network model have different model architectures. The processing unit 310 is specifically configured to monitor the prediction performance of the first positioning model according to a check value obtained by performing check with a fourth check function. The check value corresponding to the fourth check function is used for reflecting a similarity between output information of the second network model and output information of the third network model.

In some embodiments, the processing unit 310 is specifically configured to determine that the prediction result of the first positioning model is accurate in the case where the check value obtained by performing check with the fourth check function is greater than or equal to a third threshold. Additionally/alternatively, the processing unit 310 is specifically configured to determine that the prediction result of the first positioning model is inaccurate in the case where the check value obtained by performing check with the fourth check function is less than the third threshold.

In some embodiments, the processing unit 310 is specifically configured to determine that the prediction result of the first positioning model is accurate in the case where a value obtained by performing filtering on multiple check values obtained by performing check with the fourth check function within the first duration is greater than or equal to the third threshold. Additionally/alternatively, the processing unit 310 is specifically configured to determine that the prediction result of the first positioning model is inaccurate in the case where the value obtained by performing filtering on the multiple check values obtained by performing check with the fourth check function within the first duration is less than the third threshold.

In some embodiments, the processing unit 310 is specifically configured to determine that the prediction result of the first positioning model is accurate in the case where each of multiple check values obtained by performing check with the fourth check function within the first duration is greater than or equal to the third threshold. Additionally/alternatively, the processing unit 310 is specifically configured to determine that the prediction result of the first positioning model is inaccurate in the case where at least one of the multiple check values obtained by performing check with the fourth check function within the first duration is less than the third threshold.

In some embodiments, the processing unit 310 is specifically configured to determine that the prediction result of the first positioning model is accurate in the case where a probability that multiple check values obtained by performing check with the fourth check function within the first duration are greater than or equal to the third threshold is greater than or equal to a fourth threshold. Additionally/alternatively, the processing unit 310 is specifically configured to determine that the prediction result of the first positioning model is inaccurate in the case where the probability that the multiple check values obtained by performing check with the fourth check function within the first duration are greater than or equal to the third threshold is greater than or equal to the fourth threshold.

In some embodiments, the first communication device is an LMF entity, the first network model is deployed at an LMF entity side, and the first positioning model is deployed at a terminal device side.

In some embodiments, the first network model is a network model at cell granularity, and the first positioning model is a network model at terminal granularity.

In some embodiments, the first communication device is an LMF entity, both the second network model and the third network model are deployed at an LMF entity side, and the first positioning model is deployed at a terminal device side.

In some embodiments, both the second network model and the third network model are network models at cell granularity, and the first positioning model is a network model at terminal granularity.

In some embodiments, the communication device 300 further includes a communication unit 320. The communication unit 320 is configured to receive first feedback information sent by the terminal device, where the first feedback information includes the input information of the first positioning model and/or the output information of the first positioning model.

In some embodiments, before the first communication device receives the first feedback information, the communication unit 320 is further configured to send first configuration information to the terminal device, where the first configuration information is used for configuring at least one of: a feedback format of the input information of the first positioning model, feedback, by the terminal device, of the input information of the first positioning model corresponding to the first duration, a feedback format of the output information of the first positioning model, or feedback, by the terminal device, of the output information of the first positioning model corresponding to the first duration.

In some embodiments, the first configuration information is further used for triggering the terminal device to feed back the input information of the first positioning model and/or the output information of the first positioning model.

In some embodiments, before the first communication device sends the first configuration information, the communication unit 320 is further configured to receive a first model monitoring request sent by the terminal device, where the first model monitoring request is used to request monitoring of the prediction performance of the first positioning model, and the first model monitoring request triggers the first communication device to send the first configuration information.

In some embodiments, the communication unit 320 is further configured to send first monitoring information to a terminal device, where the first monitoring information indicates that the prediction result of the first positioning model is inaccurate, or the first monitoring information indicates whether the prediction result of the first positioning model is accurate.

In some embodiments, the first feedback information is information sent periodically. The first configuration information is further used for configuring period information for the terminal device to feed back the input information of the first positioning model and/or the output information of the first positioning model.

In some embodiments, the communication unit 320 is further configured to periodically send second monitoring information to the terminal device, where the second monitoring information indicates whether the prediction result of the first positioning model is accurate within a corresponding period.

In some embodiments, the first communication device is an LMF entity, and both the first network model and the first positioning model are deployed at an LMF entity side.

In some embodiments, both the first network model and the first positioning model are network models at cell granularity.

In some embodiments, the first communication device is an LMF entity, and the second network model, the third network model, and the first positioning model are all deployed at an LMF entity side.

In some embodiments, the second network model, the third network model, and the first positioning model are all network models at cell granularity.

In some embodiments, the communication unit 320 is further configured to send third monitoring information, where the third monitoring information indicates that the prediction result of the first positioning model is inaccurate.

In some embodiments, the prediction performance of the first positioning model is monitored periodically, or the prediction performance of the first positioning model is monitored aperiodically.

In some embodiments, in the case where the prediction performance of the first positioning model is monitored periodically, a monitoring period for the prediction performance of the first positioning model is defined by a protocol, or the monitoring period for the prediction performance of the first positioning model is determined by the first communication device.

In some embodiments, the first communication device is a terminal device, and both the first network model and the first positioning model are deployed at a terminal device side.

In some embodiments, both the first network model and the first positioning model are network models at terminal granularity.

In some embodiments, the first communication device is a terminal device, and the second network model, the third network model, and the first positioning model are all deployed at a terminal device side.

In some embodiments, the second network model, the third network model, and the first positioning model are all network models at terminal granularity.

In some embodiments, the communication unit 320 is further configured to send fourth monitoring information, where the fourth monitoring information indicates that the prediction result of the first positioning model is inaccurate, or the fourth monitoring information indicates whether the prediction result of the first positioning model is accurate.

In some embodiments, the communication unit 320 is further configured to receive second configuration information, where the second configuration information indicates that the first communication device is to periodically monitor the prediction performance of the first positioning model, or the second configuration information indicates that the first communication device is to aperiodically monitor the prediction performance of the first positioning model.

In some embodiments, in the case where the second configuration information indicates that the first communication device is to periodically monitor the prediction performance of the first positioning model, the second configuration information includes period information for the first communication device to monitor the prediction performance of the first positioning model, or the period information for the first communication device to monitor the prediction performance of the first positioning model is defined by a protocol, or the period information for the first communication device to monitor the prediction performance of the first positioning model is determined by the first communication device.

In some embodiments, the communication unit 320 is further configured to send fifth monitoring information, where the fifth monitoring information indicates whether the prediction result of the first positioning model is accurate within a corresponding period.

In some embodiments, in the case where the second configuration information indicates that the first communication device is to aperiodically monitor the prediction performance of the first positioning model, the second configuration information includes first time offset information, where the first time offset information indicates a time at which the first communication device reports a monitoring result of the prediction performance of the first positioning model after receiving the second configuration information.

In some embodiments, the communication unit 320 is further configured to send sixth monitoring information according to the first time offset information, where the sixth monitoring information indicates whether the prediction result of the first positioning model is accurate.

In some embodiments, the at least one network model includes a second network model and a third network model, where the second network model and the third network model have different model architectures, both the second network model and the first positioning model are deployed at a terminal device side, the third network model is deployed at an LMF entity side, and the first communication device is an LMF entity. The processing unit 310 is specifically configured to monitor the prediction performance of the first positioning model according to check information corresponding to a second check function and a check value corresponding to a third check function. The check information corresponding to the second check function is obtained from a terminal device. The check information corresponding to the second check function includes a check value corresponding to the second check function, or the check information corresponding to the second check function includes a monitoring result of the first positioning model determined based on the check value corresponding to the second check function. The check value corresponding to the second check function is used for reflecting a similarity between output information of the second network model and the input information of the first positioning model. The check value corresponding to the third check function is used for reflecting a similarity between output information of the third network model and the input information of the first positioning model.

In some embodiments, in the case where the check information corresponding to the second check function includes the check value corresponding to the second check function, the processing unit 310 is specifically configured to determine that the prediction result of the first positioning model is accurate in the case where a mean of the check value corresponding to the second check function and the check value corresponding to the third check function is greater than or equal to the first threshold. Additionally/alternatively, the processing unit 310 is specifically configured to determine that the prediction result of the first positioning model is inaccurate in the case where the mean of the check value corresponding to the second check function and the check value corresponding to the third check function is less than the first threshold.

In some embodiments, in the case where the check information corresponding to the second check function includes the monitoring result of the first positioning model determined based on the check value corresponding to the second check function, the processing unit 310 is specifically configured to determine the monitoring result of the first positioning model determined based on the check value corresponding to the second check function as a final monitoring result, or determine a monitoring result of the first positioning model determined based on the check value corresponding to the third check function as the final monitoring result. In the case where the check value corresponding to the second check function is greater than or equal to the first threshold, the monitoring result of the first positioning model indicates that the prediction result of the first positioning model is accurate; and/or in the case where the check value corresponding to the second check function is less than the first threshold, the monitoring result of the first positioning model indicates that the prediction result of the first positioning model is inaccurate. In the case where the check value corresponding to the third check function is greater than or equal to the first threshold, the monitoring result of the first positioning model indicates that the prediction result of the first positioning model is accurate; and/or in the case where the check value corresponding to the third check function is less than the first threshold, the monitoring result of the first positioning model indicates that the prediction result of the first positioning model is inaccurate.

In some embodiments, the communication unit 320 is further configured to receive the check information corresponding to the second check function and second feedback information that are sent by the terminal device, where the second feedback information includes the input information of the first positioning model and the output information of the first positioning model.

In some embodiments, before the first communication device receives the second feedback information, the communication unit 320 is further configured to send third configuration information to the terminal device, where the third configuration information is used for configuring at least one of: content contained in the check information corresponding to the second check function, a feedback format of the input information of the first positioning model, or a feedback format of the output information of the first positioning model.

In some embodiments, the third configuration information is further used for triggering the terminal device to feed back the input information of the first positioning model, the output information of the first positioning model, and the check information corresponding to the second check function.

In some embodiments, before the first communication device sends the third configuration information, the communication unit 320 is further configured to receive a second model monitoring request sent by the terminal device, where the second model monitoring request is used to request monitoring of the prediction performance of the first positioning model, and the second model monitoring request triggers the first communication device to send the third configuration information.

In some embodiments, the communication unit 320 is further configured to send seventh monitoring information to the terminal device, where the seventh monitoring information indicates that the prediction result of the first positioning model is inaccurate, or the seventh monitoring information indicates whether the prediction result of the first positioning model is accurate.

In some embodiments, the check information corresponding to the second check function and the second feedback information are information sent periodically. The third configuration information is further used for configuring at least one of: period information for the terminal device to feed back the input information of the first positioning model and the output information of the first positioning model, or period information for the terminal device to feed back the check information corresponding to the second check function.

In some embodiments, the communication unit 320 is further configured to periodically send eighth monitoring information to the terminal device, where the eighth monitoring information indicates whether the prediction result of the first positioning model is accurate within a corresponding period.

In some embodiments, the input information of the first positioning model includes at least one of: a CIR, a PDP, a DL TOA, or a DL TDOA. Additionally/alternatively, the output information of the first positioning model includes at least one of: location information of the terminal device, a DL TOA, or a DL TDOA.

In some embodiments, the communication unit may be a communication interface or a transceiver, or an input/output interface of a communication chip or an SOC. The processing unit may be one or more processors.

It may be understood that, the communication device 300 according to embodiments of the present disclosure may correspond to the first communication device in the method embodiments of the present disclosure, and the foregoing and other operations and/or functions of various units in the communication device 300 are respectively intended for implementing corresponding operations of the first communication device in the method 200 illustrated in FIG. 9, which will not be described again herein for the sake of brevity.

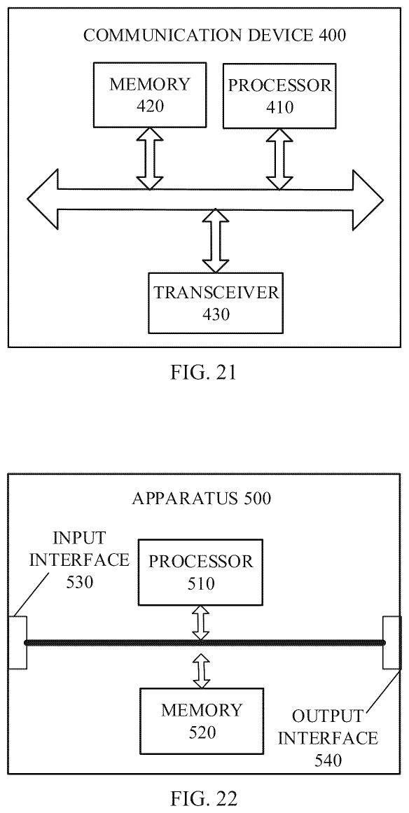

FIG. 21 is a schematic structural diagram of a communication device 400 provided in embodiments of the present disclosure. As illustrated in FIG. 21, the communication device 400 includes a processor 410, where the processor 410 can invoke and execute a computer program stored in a memory to implement the method in embodiments of the present disclosure.

In some embodiments, as illustrated in FIG. 21, the communication device 400 may further include a memory 420. The processor 410 can invoke and execute a computer program stored in the memory 420 to implement the method in embodiments of the present disclosure.

The memory 420 may be a separate device independent of the processor 410, or may be integrated into the processor 410.

In some embodiments, as illustrated in FIG. 21, the communication device 400 may further include a transceiver 430. The processor 410 may control the transceiver 430 to communicate with other devices. Specifically, the processor 410 may control the transceiver 430 to send information or data to, or receive information or data from, other devices.

The transceiver 430 may include a transmitter and a receiver. The transceiver 430 may further include one or more antennas.

In some embodiments, the processor 410 can implement the function of a processing unit in the communication device 300, which is not repeated herein for the sake of brevity.

In some embodiments, the transceiver 430 can implement the function of a communication unit in the communication device 300, which is not repeated herein for the sake of brevity.

In some embodiments, the communication device 400 may specifically be the communication device 300 in embodiments of the present disclosure, and the communication device 400 may implement corresponding operations implemented by the first communication device in various methods in embodiments of the present disclosure, which will not be repeated herein for the sake of brevity.

FIG. 22 is a schematic structural diagram of an apparatus provided in embodiments of the present disclosure. As illustrated in FIG. 22, the apparatus 500 includes a processor 510, where the processor 510 can invoke and execute a computer program stored in a memory to implement the method in embodiments of the present disclosure.

In some embodiments, as illustrated in FIG. 22, the apparatus 500 may further include a memory 520. The processor 510 can invoke and execute a computer program stored in the memory 520 to implement the method in embodiments of the present disclosure.

The memory 520 may be a separate device independent of the processor 510, or may be integrated into the processor 510.

In some embodiments, the processor 510 can implement the function of a processing unit in the communication device 300, which is not repeated herein for the sake of brevity.

In some embodiments, the apparatus 500 may further include an input interface 530. The processor 510 may control the input interface 530 to communicate with other devices or chips. Specifically, the processor 510 can obtain information or data sent by other devices or chips. Optionally, the processor 510 may be disposed inside or outside a chip.

In some embodiments, the input interface 530 can implement the function of the communication unit in the communication device 300.

In some embodiments, the apparatus 500 may further include an output interface 540. The processor 510 may control the output interface 540 to communicate with other devices or chips. Specifically, the processor 510 may output information or data to other devices or chips. Optionally, the processor 510 may be disposed inside or outside a chip.

In some embodiments, the output interface 540 can implement the function of the communication unit in the communication device 300.

In some embodiments, the apparatus is applicable to the communication device 300 in embodiments of the present disclosure, and the apparatus may implement the corresponding operations performed by the first communication device in various methods of embodiments of the present disclosure. For the sake of brevity, such details are not repeated herein.

It may be understood that, the apparatus in embodiments of the present disclosure may also be a chip, such as a system-level chip, a system chip, a chip system, or a system-on-chip (SOC).

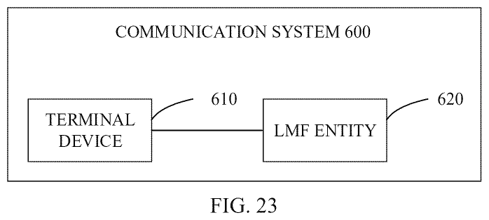

FIG. 23 is a schematic block diagram of a communication system 600 provided in embodiments of the present disclosure. As illustrated in FIG. 23, the communication system 600 includes a terminal device 610 and an LMF entity 620.

The terminal device 610 may be configured to implement the corresponding functions performed by the terminal device in the method, and the LMF entity 620 may be configured to implement the corresponding functions performed by the LMF entity in the method. For the sake of brevity, such details are not repeated herein.

It may be understood that, the processor in embodiments of the present disclosure may be an integrated circuit chip with signal processing capabilities. During implementation, each step of the foregoing method embodiments may be completed by an integrated logic circuit of hardware in the processor or an instruction in the form of software. The processor may be a general-purpose processor, a digital signal processor (DSP), an ASIC, a field programmable gate array (FPGA), or other programmable logic devices, discrete gates or transistor logic devices, discrete hardware components. The methods, steps, and logic blocks disclosed in embodiments of the present disclosure can be implemented or executed. The general-purpose processor may be a microprocessor, or the processor may be any conventional processor or the like. The steps of the method disclosed in embodiments of the present disclosure may be directly implemented by a hardware decoding processor, or may be performed by hardware and software models in the decoding processor. The software model can be located in a storage medium mature in the skill, such as a random access memory (RAM), a flash memory, a read-only memory (ROM), a programmable ROM (PROM), or an electrically erasable programmable memory, registers, and the like. The storage medium is located in the memory. The processor reads the information in the memory, and completes the steps of the method described above with the hardware of the processor.

It may be understood that, the memory in embodiments of the present disclosure may be a volatile memory or a non-volatile memory, or may include both the volatile memory and the non-volatile memory. The non-volatile memory may be a ROM, a PROM, an erasable PROM (EPROM), an electrically EPROM (EEPROM), or a flash memory. The volatile memory may be a RAM that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It may be noted that, the memory of the systems and methods described in the present disclosure is intended to include, but is not limited to, these and any other suitable types of memory.

It may be understood that, the memory above is intended for illustration rather than limitation. For example, the memory in embodiments of the present disclosure may also be an SRAM, a DRAM, an SDRAM, a DDR SDRAM, an ESDRAM, an SLDRAM, a DR RAM, etc.

In other words, the memory in embodiments of the present disclosure is intended to include, but is not limited to, these and any other suitable types of memory.

A computer-readable storage medium is further provided in embodiments of the present disclosure. The computer-readable storage medium is configured to store a computer program.

In some embodiments, the computer-readable storage medium may be applied to the first communication device in embodiments of the present disclosure, and the computer program causes a computer to perform corresponding operations implemented by the first communication device in various methods in embodiments of the present disclosure, which will not be repeated herein for the sake of simplicity.

A computer program product is further provided in embodiments of the present disclosure. The computer program product includes computer program instructions.

In some embodiments, the computer program product may be applied to the first communication device in embodiments of the present disclosure, and the computer program instructions cause a computer to perform corresponding operations implemented by the first communication device in various methods in embodiments of the present disclosure, which will not be repeated herein for the sake of simplicity.

A computer program is further provided in embodiments of the present disclosure.

In some embodiments, the computer program may be applied to the first communication device in embodiments of the present disclosure. The computer program, when executed by a computer, causes the computer to perform corresponding operations implemented by the first communication device in various methods in embodiments of the present disclosure, which will not be repeated herein for the sake of simplicity.

It will be appreciated by those of ordinary skill in the art that units and algorithmic operations of various examples described in connection with embodiments of the present disclosure can be implemented by electronic hardware or by a combination of computer software and electronic hardware. Whether these functions are performed by means of hardware or software depends on the application and the design constraints of the associated technical solution. Those skilled in the art may use different methods with regard to each particular application to implement the described functionality, but such methods should not be regarded as lying beyond the scope of the present disclosure.

It will be evident to those skilled in the art that, for the sake of convenience and brevity, in terms of the specific working processes of the foregoing systems, apparatuses, and units, reference can be made to the corresponding processes in the foregoing method embodiments, which will not be repeated herein.

It will be appreciated that the systems, apparatuses, and methods disclosed in embodiments of the present disclosure may also be implemented in various other manners. For example, the above apparatus embodiments are merely illustrative, e.g., the division of units is only a division of logical functions, and other manners of division may be available in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interface, device, or unit, and may be electrical, mechanical, or otherwise.

Separated units as illustrated may or may not be physically separated. Components displayed as units may or may not be physical units, and may reside at one location or may be distributed to multiple networked units. Some or all of the units may be selectively adopted according to practical needs to achieve desired objectives of the present disclosure.

In addition, various functional units described in various embodiments of the present disclosure may be integrated into one processing unit or may be present as a number of physically separated units, and two or more units may be integrated into one.

If the functions are implemented as software functional units and sold or used as standalone products, they may be stored in a computer-readable storage medium. Based on such an understanding, the essential technical solution, or the portion that contributes to the prior art, or part of the technical solution of the present disclosure may be embodied as software products. The computer software products can be stored in a storage medium and may include multiple instructions that, when executed, can cause a computer device, e.g., a personal computer, a server, a network device, etc., to execute some or all operations of the methods described in various embodiments of the present disclosure. The above storage medium may include various kinds of media that can store program codes, such as a universal serial bus (USB) flash disk, a mobile hard drive, an ROM, an RAM, a magnetic disk, or an optical disk.

The foregoing elaborations are merely embodiments of the present disclosure, but are not intended to limit the protection scope of the present disclosure. Any variation or replacement easily thought of by those skilled in the art within the technical scope disclosed in the present disclosure shall belong to the protection scope of the present disclosure. Therefore, the protection scope of the present disclosure shall be subject to the protection scope of the claims.

What is claimed is:

1. A method for wireless communication, comprising:
monitoring, by a communication device, prediction performance of a first positioning model according to at least one network model;
wherein input information of the at least one network model is output information of the first positioning model, or the input information of the at least one network model is determined based on the output information of the first positioning model, or the input information of the at least one network model is associated with the output information of the first positioning model; and
wherein output information of the at least one network model is an estimation of input information of the first positioning model.

2. The method of claim 1, wherein:
the at least one network model comprises a first network model; and
monitoring, by the communication device, the prediction performance of the first positioning model according to the at least one network model comprises:
monitoring, by the communication device, the prediction performance of the first positioning model according to a check value obtained by performing check with a first check function;
wherein the check value corresponding to the first check function is used for reflecting a similarity between output information of the first network model and the input information of the first positioning model.

3. The method of claim 2, wherein monitoring, by the communication device, the prediction performance of the first positioning model according to the check value obtained by performing check with the first check function comprises at least one of:
in a case where the check value obtained by performing check with the first check function is greater than or equal to a first threshold, determining, by the communication device, that a prediction result of the first positioning model is accurate; or
in a case where the check value obtained by performing check with the first check function is less than the first threshold, determining, by the communication device, that the prediction result of the first positioning model is inaccurate.

4. The method of claim 2, wherein monitoring, by the communication device, the prediction performance of the first positioning model according to the check value obtained by performing check with the first check function comprises at least one of:
in a case where a value obtained by performing filtering on a plurality of check values obtained by performing check with the first check function within a first duration is greater than or equal to a first threshold, determining, by the communication device, that a prediction result of the first positioning model is accurate; or
in a case where the value obtained by performing filtering on the plurality of check values obtained by performing check with the first check function within the first duration is less than the first threshold, determining, by the communication device, that the prediction result of the first positioning model is inaccurate.

5. The method of claim 2, wherein monitoring, by the communication device, the prediction performance of the first positioning model according to the check value obtained by performing check with the first check function comprises at least one of:
in a case where each of a plurality of check values obtained by performing check with the first check function within a first duration is greater than or equal to a first threshold, determining, by the communication device, that a prediction result of the first positioning model is accurate; or
in a case where at least one of the plurality of check values obtained by performing check with the first check function within the first duration is less than the first threshold, determining, by the communication device, that the prediction result of the first positioning model is inaccurate.

6. The method of claim 2, wherein monitoring, by the communication device, the prediction performance of the first positioning model according to the check value obtained by performing check with the first check function comprises at least one of:
in a case where a probability that a plurality of check values obtained by performing check with the first check function within a first duration are greater than or equal to a first threshold is greater than or equal to a second threshold, determining, by the communication device, that a prediction result of the first positioning model is accurate; or
in a case where the probability that the plurality of check values obtained by performing check with the first check function within the first duration are greater than or equal to the first threshold is less than the second threshold, determining, by the communication device, that the prediction result of the first positioning model is inaccurate.

7. The method of claim 1, wherein:
the at least one network model comprises a second network model and a third network model, wherein the second network model and the third network model have different model architectures; and
monitoring, by the communication device, the prediction performance of the first positioning model according to the at least one network model comprises:
monitoring, by the communication device, the prediction performance of the first positioning model according to a check value obtained by performing check with a second check function and a check value obtained by performing check with a third check function;
wherein the check value corresponding to the second check function is used for reflecting a similarity between output information of the second network model and the input information of the first positioning model, and the check value corresponding to the third check function is used for reflecting a similarity between output information of the third network model and the input information of the first positioning model.

8. The method of claim 7, wherein monitoring, by the communication device, the prediction performance of the first positioning model according to the check value obtained by performing check with the second check function and the check value obtained by performing check with the third check function comprises at least one of:
in a case where a mean of the check value corresponding to the second check function and the check value corresponding to the third check function is greater than or equal to a first threshold, determining, by the communication device, that a prediction result of the first positioning model is accurate; or
in a case where the mean of the check value corresponding to the second check function and the check value corresponding to the third check function is less than the first threshold, determining, by the communication device, that the prediction result of the first positioning model is inaccurate.

9. The method of claim 7, wherein monitoring, by the communication device, the prediction performance of the first positioning model according to the check value obtained by performing check with the second check function and the check value obtained by performing check with the third check function comprises at least one of:
in a case where a mean of a value obtained by performing filtering on a plurality of check values obtained by performing check with the second check function within a first duration and a value obtained by performing filtering on a plurality of check values obtained by performing check with the third check function within the first duration is greater than or equal to a first threshold, determining, by the communication device, that a prediction result of the first positioning model is accurate; or
in a case where the mean of the value obtained by performing filtering on the plurality of check values obtained by performing check with the second check function within the first duration and the value obtained by performing filtering on the plurality of check values obtained by performing check with the third check function within the first duration is less than the first threshold, determining, by the communication device, that the prediction result of the first positioning model is inaccurate.

10. The method of claim 7, wherein monitoring, by the communication device, the prediction performance of the first positioning model according to the check value obtained by performing check with the second check function and the check value obtained by performing check with the third check function comprises at least one of:
in a case where a mean of a plurality of check values obtained by performing check with the second check function within a first duration and a plurality of check values obtained by performing check with the third check function within the first duration is greater than or equal to a first threshold, determining, by the communication device, that a prediction result of the first positioning model is accurate; or
in a case where the mean of the plurality of check values obtained by performing check with the second check function within the first duration and the plurality of check values obtained by performing check with the third check function within the first duration is less than the first threshold, determining, by the communication device, that the prediction result of the first positioning model is inaccurate.

11. A communication device comprising:
a processor; and
a memory storing a computer program which, when executed by the processor, causes the communication device to:
monitor prediction performance of a first positioning model according to at least one network model;
wherein input information of the at least one network model is output information of the first positioning model, or the input information of the at least one network model is determined based on the output information of the first positioning model, or the input information of the at least one network model is associated with the output information of the first positioning model; and
wherein output information of the at least one network model is an estimation of input information of the first positioning model.

12. The communication device of claim 11, wherein:
the at least one network model comprises a first network model; and
the computer program executed by the processor to cause the communication device to monitor the prediction performance of the first positioning model according to the at least one network model is executed by the processor to cause the communication device to:
monitor the prediction performance of the first positioning model according to a check value obtained by performing check with a first check function;
wherein the check value corresponding to the first check function is used for reflecting a similarity between output information of the first network model and the input information of the first positioning model.

13. The communication device of claim 12, wherein the computer program executed by the processor to cause the communication device to monitor the prediction performance of the first positioning model according to the check value obtained by performing check with the first check function is executed by the processor to cause the communication device to perform at least one of:
in a case where the check value obtained by performing check with the first check function is greater than or equal to a first threshold, determining that a prediction result of the first positioning model is accurate; or
in a case where the check value obtained by performing check with the first check function is less than the first threshold, determining that the prediction result of the first positioning model is inaccurate.

14. The communication device of claim 12, wherein the computer program executed by the processor to cause the communication device to monitor the prediction performance of the first positioning model according to the check value obtained by performing check with the first check function is executed by the processor to cause the communication device to perform at least one of:
in a case where a value obtained by performing filtering on a plurality of check values obtained by performing check with the first check function within a first duration is greater than or equal to a first threshold, determining that a prediction result of the first positioning model is accurate; or
in a case where the value obtained by performing filtering on the plurality of check values obtained by performing check with the first check function within the first duration is less than the first threshold, determining that the prediction result of the first positioning model is inaccurate.

15. The communication device of claim 12, wherein the computer program executed by the processor to cause the communication device to monitor the prediction performance of the first positioning model according to the check value obtained by performing check with the first check function is executed by the processor to cause the communication device to perform at least one of:
in a case where each of a plurality of check values obtained by performing check with the first check function within a first duration is greater than or equal to a first threshold, determining that a prediction result of the first positioning model is accurate; or
in a case where at least one of the plurality of check values obtained by performing check with the first check function within the first duration is less than the first threshold, determining that the prediction result of the first positioning model is inaccurate.

16. The communication device of claim 12, wherein the computer program executed by the processor to cause the communication device to monitor the prediction performance of the first positioning model according to the check value obtained by performing check with the first check function is executed by the processor to cause the communication device to perform at least one of:
in a case where a probability that a plurality of check values obtained by performing check with the first check function within a first duration are greater than or equal to a first threshold is greater than or equal to a second threshold, determining that a prediction result of the first positioning model is accurate; or
in a case where the probability that the plurality of check values obtained by performing check with the first check function within the first duration are greater than or equal to the first threshold is less than the second threshold, determining that the prediction result of the first positioning model is inaccurate.

17. The communication device of claim 11, wherein:
the at least one network model comprises a second network model and a third network model, wherein the second network model and the third network model have different model architectures; and
the computer program executed by the processor to cause the communication device to monitor the prediction performance of the first positioning model according to the at least one network model is executed by the processor to cause the communication device to:
monitor the prediction performance of the first positioning model according to a check value obtained by performing check with a second check function and a check value obtained by performing check with a third check function;
wherein the check value corresponding to the second check function is used for reflecting a similarity between output information of the second network model and the input information of the first positioning model, and the check value corresponding to the third check function is used for reflecting a similarity between output information of the third network model and the input information of the first positioning model.

18. The communication device of claim 17, wherein the computer program executed by the processor to cause the communication device to monitor the prediction performance of the first positioning model according to the check value obtained by performing check with the second check function and the check value obtained by performing check with the third check function is executed by the processor to cause the communication device to perform at least one of:
in a case where a mean of the check value corresponding to the second check function and the check value corresponding to the third check function is greater than or equal to a first threshold, determining that a prediction result of the first positioning model is accurate; or
in a case where the mean of the check value corresponding to the second check function and the check value corresponding to the third check function is less than the first threshold, determining that the prediction result of the first positioning model is inaccurate.

19. The communication device of claim 17, wherein the computer program executed by the processor to cause the communication device to monitor the prediction performance of the first positioning model according to the check value obtained by performing check with the second check function and the check value obtained by performing check with the third check function is executed by the processor to cause the communication device to perform at least one of:
in a case where a mean of a value obtained by performing filtering on a plurality of check values obtained by performing check with the second check function within a first duration and a value obtained by performing filtering on a plurality of check values obtained by performing check with the third check function within the first duration is greater than or equal to a first threshold, determining that a prediction result of the first positioning model is accurate; or
in a case where the mean of the value obtained by performing filtering on the plurality of check values obtained by performing check with the second check function within the first duration and the value obtained by performing filtering on the plurality of check values obtained by performing check with the third check function within the first duration is less than the first threshold, determining that the prediction result of the first positioning model is inaccurate.

20. The communication device of claim 17, wherein the computer program executed by the processor to cause the communication device to monitor the prediction performance of the first positioning model according to the check value obtained by performing check with the second check function and the check value obtained by performing check with the third check function is executed by the processor to cause the communication device to perform at least one of:
in a case where a mean of a plurality of check values obtained by performing check with the second check function within a first duration and a plurality of check values obtained by performing check with the third check function within the first duration is greater than or equal to a first threshold, determining that a prediction result of the first positioning model is accurate; or
in a case where the mean of the plurality of check values obtained by performing check with the second check function within the first duration and the plurality of check values obtained by performing check with the third check function within the first duration is less than the first threshold, determining that the prediction result of the first positioning model is inaccurate.
